(19) United States
(12) Patent Application Publication
(10) Pub. No.: US 2025/0361578 A1
(43) Pub. Date: Nov. 27, 2025

(54) SYSTEMS AND METHODS FOR ELECTROCHEMICALLY ENABLE RECYCLING OF CDTE PHOTOVOLTAICS

(71) Applicant: Battelle Energy Alliance, LLC, Idaho Falls, ID (US)

(72) Inventors: Luis A. Diaz Aldana, Idaho Falls, ID (US); Reyixiati Repukaiti, Idaho Falls, ID (US); Meng Shi, Idaho Falls, ID (US); Arindam Mukhopadhyay, Ammon, ID (US)

(21) Appl. No.: 19/216,998

(22) Filed: May 23, 2025

Related U.S. Application Data
(60) Provisional application No. 63/651,281, filed on May 23, 2024.

(51) Int. Cl. C22B 7/00; C22B 3/00

(52) U.S. Cl. CPC C22B 7/007; C22B 17/04

(57) ABSTRACT

An electrochemical leaching system for recovering metals from electronic waste comprises an electrochemical cell configured to produce a hydrogen peroxide-enriched electrolyte. A power supply is in electrical communication with the electrochemical cell and a leaching reactor is configured to contain fragmented electronic waste and to produce a metal-enriched electrolyte from the fragmented electronic waste. The electrochemical cell and the leaching reactor are in fluid communication with each other. Related methods are also disclosed.

### CROSS-REFERENCE TO RELATED APPLICATIONS

This application claims the benefit under 35 U.S.C. § 119(e) of U.S. Provisional Patent Application Ser. No. 63/651,281, filed May 23, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure relate generally to systems and methods of recovering metals of interest from electronic waste. More particularly, embodiments of the disclosure relate to electrochemical leaching systems that are configured to include the in situ generation of hydrogen peroxide for use with an electrolyte.

### BACKGROUND

The rapid growth of the electronics and renewable energy sectors has led to a corresponding increase in electronic waste (e-waste), including end-of-life devices such as printed circuit boards and photovoltaic (PV) solar panels. These materials often contain significant quantities of valuable metals—including precious metals, base metals, and semiconductor elements—embedded within complex composite structures. As the volume and diversity of e-waste continue to rise, so too does the need for efficient, scalable, and environmentally responsible methods to recover these critical resources.

Currently, the metals contained in electronic waste are not sufficiently recovered prior to disposing the electronic waste. In some instances, the electronic waste is landfilled or combusted (e.g., incinerated) without recovering a significant portion of the metals therein. Landfilling the electronic waste has the potential to contaminate soil and underground water. The combustion process may release toxic compounds into the atmosphere.

Methods of recovering the metals in the electronic waste have been proposed. Emerging recycling strategies have focused on enhancing the selectivity and sustainability of leaching and recovery processes through the application of electrochemical systems.

### BRIEF SUMMARY

An electrochemical leaching system for recovering metals from electronic waste is disclosed and comprises an electrochemical cell configured to produce a hydrogen peroxide-enriched electrolyte. A power supply is in electrical communication with the electrochemical cell and a leaching reactor is configured to contain fragmented electronic waste and to produce a metal-enriched electrolyte from the fragmented electronic waste. The electrochemical cell and the leaching reactor are in fluid communication with each other.

A method of recovering one or more metals from electronic waste is disclosed and comprises introducing fragmented electronic waste into a leaching reactor. An electrolyte is introduced into an electrochemical cell in fluid communication with the leaching reactor. An oxygen containing gas is introduced into the electrochemical cell and an electrical potential is applied to the electrochemical cell to produce hydrogen peroxide from the oxygen containing gas in the electrochemical cell. The hydrogen peroxide is combined with the electrolyte to form a hydrogen peroxide-enriched electrolyte and the fragmented electronic waste in the leaching reactor is contacted with the hydrogen peroxide-enriched electrolyte to dissolve at least one metal from the fragmented electronic waste into the electrolyte and to form a metal-enriched electrolyte. One or more metals are recovered from the metal-enriched electrolyte.

Another method of recovering one or more metals from electronic waste is disclosed and comprises introducing fragmented electronic waste from solar panels into a leaching reactor. An electrolyte is introduced into an electrochemical cell in fluid communication with the leaching reactor. An oxygen containing gas is introduced into the electrochemical cell and an electrical current is applied between an anode and a cathode of the electrochemical cell to produce hydrogen peroxide in the electrochemical cell. The hydrogen peroxide is combined with the electrolyte to form a hydrogen peroxide-enriched electrolyte. At least one metal is leached from the fragmented electronic waste into the hydrogen peroxide-enriched electrolyte to form a metal-enriched electrolyte. The at least one metal is recovered from the metal-enriched electrolyte to form a metal-depleted electrolyte. The metal-depleted electrolyte is combined with hydrogen peroxide in the electrochemical cell.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 illustrates an electrochemical leaching system, in accordance with embodiments of the disclosure;

FIG. 2 illustrates an electrochemical cell, in accordance with embodiments of the disclosure;

FIG. 3 illustrates a flow diagram of a method of recovering metals of interest from electronic waste, in accordance with embodiments of the disclosure;

FIG. 4 illustrates an electrochemical cell, in accordance with embodiments of the disclosure;

FIG. 5 illustrates an electrochemical leaching system, in accordance with embodiments of the disclosure;

FIG. 6 illustrates a flow diagram of a method of recovering metals of interest from electronic waste, in accordance with embodiments of the disclosure;

FIG. 7 illustrates an electrochemical leaching system, in accordance with embodiments of the disclosure;

FIG. 8 illustrates a flow diagram of a method of recovering metals of interest from electronic waste, in accordance with embodiments of the disclosure;

FIG. 9 is a graph comparing the weight on each sieve and the cumulative percentage weight retained based on sieve mesh size, in accordance with embodiments of the disclosure;

FIG. 10 is a graph of the correlation between weight percent (wt %) of the metals of interest in each sieve and CdTe solar cell particle weight retained in each sieve, in accordance with embodiments of the disclosure;

FIG. 11 is a graph of the leaching yields of Cd and Te at varying values for H₂O₂ concentration, in accordance with embodiments of the disclosure;

FIG. 12 is a graph of the leaching yields of Cd and Te at varying values for total current, in accordance with embodiments of the disclosure;

FIG. 13 illustrates a flowsheet of an electrochemical leaching system, in accordance with embodiments of the disclosure;

FIG. 14A is a graph of a H₂O₂ concentration curve, in accordance with embodiments of the disclosure;

FIG. 14B is a graph that shows the relationship between time and H₂O₂ concentration at varying values for applied current, in accordance with embodiments of the disclosure;

FIG. 14C is a graph that shows the relationship between time and H₂O₂ concentration at varying values for catholyte volume, in accordance with embodiments of the disclosure;

FIG. 14D is a graph that shows the relationship between time and H₂O₂ concentration while using pure oxygen and air as a feed gas, in accordance with embodiments of the disclosure;

FIG. 15A is a graph that shows the relationship between applied current and leaching efficiency of Cd and Te, in accordance with embodiments of the disclosure;

FIG. 15B is a graph that shows the relationship between leaching time and leaching efficiency of Cd and Te, in accordance with embodiments of the disclosure;

FIG. 15C is a graph that shows the relationship between feed gas flow rate/composition and leaching efficiency of Cd and Te, in accordance with embodiments of the disclosure;

FIG. 16A illustrates a thermodynamic computational simulation, in accordance with embodiments of the disclosure;

FIG. 16B illustrates a thermodynamic computational simulation, in accordance with embodiments of the disclosure;

FIG. 16C illustrates a thermodynamic computational simulation, in accordance with embodiments of the disclosure;

FIG. 17A is a graph that shows the relationship between ED time and percent metal recovery via ED at varying values for cathodic reduction potential, in accordance with embodiments of the disclosure;

FIG. 17B is a graph that shows the relationship between ED time and percent metal recovery via ED at varying values for cathodic reduction potential, in accordance with embodiments of the disclosure;

FIG. 17C is a graph that shows the relationship between cathodic reduction potential and the Te: Cd recovery ratio at varying ED times, in accordance with embodiments of the disclosure;

FIG. 17D is a graph that shows the relationship between cathodic reduction potential and total metal recovery via ED, in accordance with embodiments of the disclosure;

FIG. 17E is a graph that shows the relationship between cathodic reduction potential and metal purity in ED deposit, in accordance with embodiments of the disclosure;

FIG. 18A is a graph that shows metal recovery yield at varying EW conditions, in accordance with embodiments of the disclosure;

FIG. 18B is a graph that shows metal recovery yield at varying EW conditions, in accordance with embodiments of the disclosure;

FIG. 18C is a graph that shows metal recovery yield at varying EW conditions, in accordance with embodiments of the disclosure;

FIG. 19A is a graph that shows the ratio of recovery yields for Te: Cd, Te: Se, and Te: Al at varying EW conditions, in accordance with embodiments of the disclosure; and

FIG. 19B is a graph that shows the metal purity in deposit at varying EW conditions, in accordance with embodiments of the disclosure.

### DETAILED DESCRIPTION

Systems and methods for recovering metals of interest from electronic waste through an electrochemical leaching process are described. The systems and methods include the in situ generation of hydrogen peroxide (H₂O₂) via an electrochemical reaction, using a gas diffusion electrode in an electrochemical cell supplied with an oxygen containing gas. The produced hydrogen peroxide is combined with an electrolyte in the electrochemical cell to produce a hydrogen peroxide-enriched electrolyte. The hydrogen peroxide in the enriched electrolyte functions as an oxidizer to leach metals of interest, such as cadmium and tellurium, from the electronic waste. The leaching occurs within a leaching reactor and produces a metal-enriched electrolyte that contains solubilized metal ions. These solubilized metal ions are subsequently recovered from the enriched electrolyte using electrowinning or electroplating in a recovery electrochemical cell to produce a depleted electrolyte. The electrochemical leaching process forms a closed-loop system where the depleted electrolyte is continuously cycled (e.g., reused) in the electrochemical leaching process and re-enriched with hydrogen peroxide, minimizing the use of external reagents. The recovery of the solubilized metal ions may occur before the leaching or after the leaching. The recovery of the solubilized metal ions may occur in a recovery electrochemical cell that is external to the closed-loop system. Alternatively, the solubilized metal ions may be recovered by chemical methods, such as by ion exchange or co-precipitation. The chemical methods may be used to isolate one or more of the solubilized metal ions within a closed-loop or in a process that is external to the closed-loop system.

The illustrations presented herein are not actual views of any system, reactor, component thereof, or method but are merely idealized representations, which are employed to describe embodiments of the disclosure.

As used herein, the singular forms following “a,” “an,” and “the” are intended to include the plural forms as well, unless the context clearly indicates otherwise.

The terms “have,” “may have,” “include,” and “may include” as used herein indicate the presence of corresponding features (for example, elements such as numerical values, functions, operations, or parts), and do not preclude the presence of additional features.

The word “exemplary” is used herein to mean “serving as an example or illustration.” Any aspect or design described herein as “exemplary” is not necessarily to be construed as preferred or advantageous over other aspects or designs.

The terms “A or B,” “at least one of A and B,” “one or more of A and B,” or “A and/or B” as used herein include all possible combinations of items enumerated with them. For example, use of these terms, with A and B representing different items, means: (1) including at least one A; (2) including at least one B; or (3) including both at least one A and at least one B. In addition, the articles “a” and “an” as used herein should generally be construed to mean “one or more” unless specified otherwise or clear from the context to be directed to a singular form.

Terms such as “first,” “second,” and so forth are used herein to distinguish one component from another without limiting the components and do not necessarily reflect importance, quantity, or an order of use. For example, a first user device and a second user device may indicate different user devices regardless of the order or importance. Furthermore, a reference to first and second elements does not mean that only two elements may be employed there or that the first element must precede the second element in some manner. Also, unless stated otherwise a set of elements may comprise one or more elements.

It will be understood that, when two or more elements are described as being “coupled,” “operatively coupled,” “connected,” “in communication,” “in connection” or “in operable communication” with or to each other, the connection or communication may be direct, or there may be an intervening element between the two or more elements. Conversely, it will be understood that when two or more elements are described as being “directly” coupled with or to another element, “directly” connected with or to another element, or in “direct communication” with or to another element, there is no intervening element between the first two or more elements.

The “coupling,” “communication,” or “connections” between elements may be, without limitation, wired, wireless, electrical, mechanical, optical, chemical, electrochemical, fluid, comparative, by sensing, or in any other way two or more elements interact, communicate, or acknowledge each other. It will further be appreciated that elements may be “connected” with or to each other, or in “communication” with or to each other by way of local or remote processes, local or remote devices or systems, distributed devices, or systems, or across local or area networks, telecommunication networks, the Internet, other data communication networks conforming to a variety of protocols, or combinations of any of these. Thus, by way of non-limiting example, units, components, modules, elements, devices, and the like may be “connected,” or “communicate” with each other locally or remotely by means of a coaxial cable, fiber optic cable, twisted pair, digital subscriber line (DSL), shared chipset or wireless technologies such as infrared, radio, and microwave.

The expression “configured to” as used herein may be used interchangeably with “suitable for,” “having the capacity to,” “designed to,” “adapted to,” “made to,” or “capable of” according to a context. The term “configured” does not necessarily mean “specifically designed to” in a hardware level. Instead, the expression “apparatus configured to” may mean that the apparatus is “capable of” along with other devices or parts in a certain context.

The term “majority” in reference to a given parameter, property, or condition means and includes to a degree that one of ordinary skill in the art would understand that the given parameter, property, or condition is met with a degree of variance, such as within acceptable tolerances. By way of example, the parameter, property, or condition shall be at least greater than 50%, such as greater than about 51%, or from about 51% to about 60%, or from about 61% to about 70%, or from about 71% to about 80%, or from about 81% to about 90%.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

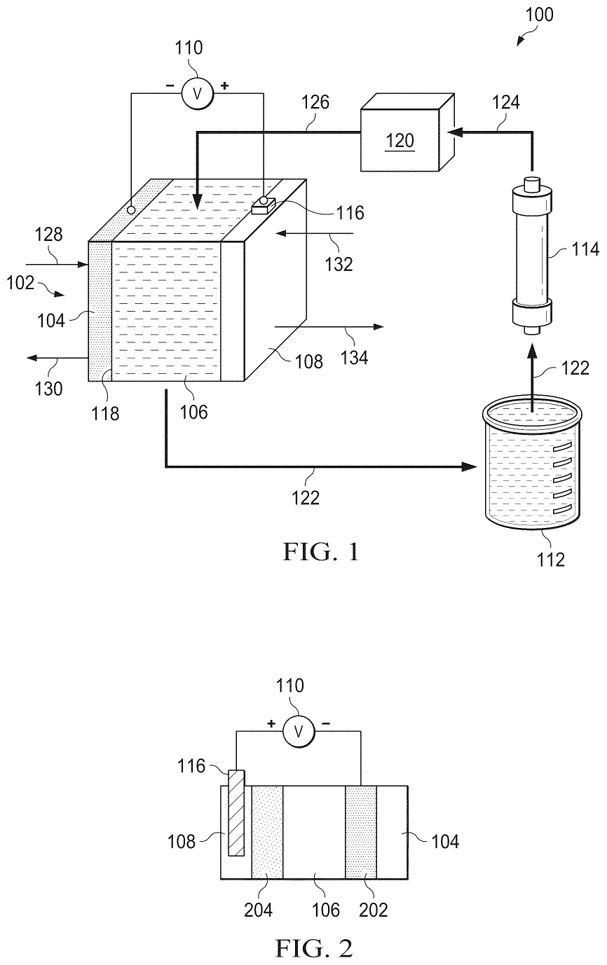

FIG. 1 is an electrochemical leaching system 100 configured for use in a metal recovery process. Using electrochemistry may offer precise control over redox reactions conducted in the electrochemical leaching system 100 and may enable the generation or activation of leaching agents directly within the process loop, reducing reliance on externally sourced reagents. The systems and methods for recovering metals of interest from the electronic waste may enable recovering substantially pure metals of interest from the electronic waste without consuming large amounts of corrosive reagents. While embodiments herein describe recovering metals of interest from electronic waste, the metals of interest may be recovered from other feed streams (e.g., fragmented metal containing materials). The fragmented metal containing material may include, for example, ore concentrates from which metals such as gold, silver, uranium, copper, cobalt, nickel, or others, may be recovered.

The electrochemical leaching system 100 includes a first electrochemical cell 102, a recirculation vessel 112, a leaching reactor 114, and, optionally, a second electrochemical cell 120. The first electrochemical cell 102 may be in fluid connection with the second electrochemical cell 120 and the recirculation vessel 112, the recirculation vessel 112 may be in fluid connection with the first electrochemical cell 102 and leaching reactor 114, the leaching reactor 114 may be in fluid connection with the recirculation vessel 112 and the second electrochemical cell 120, and the second electrochemical cell 120 may be in fluid connection with the leaching reactor 114 and the first electrochemical cell 102. The first electrochemical cell 102, recirculation vessel 112, leaching reactor 114, and second electrochemical cell 120 are components (e.g., process units) of the electrochemical leaching system 100 and are used in the electrochemical leaching process where the output of one component is used as the input for another component. The electrochemical leaching system 100 may also include a power supply 110 connected to an anode 116 and a cathode 118 of the first electrochemical cell 102.

An enlargement of the first electrochemical cell 102 is shown in FIG. 2. The first electrochemical cell 102 may include multiple chambers, such as a cathode chamber 104, an electrolyte chamber 106, and an anode chamber 108. The chambers in the first electrochemical cell 102 may each contain a different material during use and operation of the electrochemical leaching system 100. For example, the cathode chamber 104 of the first electrochemical cell 102 may contain an oxygen rich gas, the electrolyte chamber 106 may contain the electrolyte that is formulated as the catholyte, and the anode chamber 108 may contain an anolyte during use and operation of the first electrochemical cell 102. The first electrochemical cell 102 may be, for example, an electrochemical flow cell that allows for conducting continuous electrochemical reactions by permitting a constant flow of the electrolyte through the electrolyte chamber 106. While FIG. 2 shows three chambers in the first electrochemical cell 102, more or fewer chambers may be present.

The chambers in the first electrochemical cell 102 may be separated from each other with different materials. For example, the gas in the cathode chamber 104 may be separated from the electrolyte in the electrolyte chamber 106 by a gas diffusion electrode 202, and the electrolyte in the electrolyte chamber 106 may be separated from the anolyte in the anode chamber 108 with a membrane 204. The membrane 204 may include, for example, a bipolar membrane or a cation exchange membrane that allows for ionic conductivity between the electrolyte and the anolyte.

Referring again to FIG. 1, the electrolyte in the electrolyte chamber 106 may flow throughout the different process units in the electrochemical leaching system 100 and may experience changes in material composition as it enters and exits the different process units. For example, the electrolyte may enter the first electrochemical cell 102 as a metal-depleted electrolyte 126 and exit as a hydrogen peroxide-enriched electrolyte 122. The hydrogen peroxide-enriched electrolyte 122 may enter the leaching reactor 114 and exit as a metal-enriched electrolyte 124. The metal-enriched electrolyte 124 may enter the second electrochemical cell 120 and exit as a metal-depleted electrolyte 126. Furthermore, the cathode chamber 104 may be in fluid connection with an oxygen containing gas input 128 and an oxygen containing gas output 130 that allow an oxygen containing gas to continually flow through the cathode chamber 104. The anode chamber 108 may be in fluid connection with an anolyte input 132 and anolyte output 134 that allow the anolyte to continually flow through the anode chamber 108.

One or more pumps (not shown) may be used to move different gaseous and/or aqueous solutions through the different chambers 104, 106, and 108 in the first electrochemical cell 102. For example, a pump may be in fluid connection with the electrolyte chamber 106 and may be configured to move the electrolyte through the electrolyte chamber 106. Another pump may be in fluid connection with the anode chamber 108 through the anolyte input 132 and anolyte output 134 and may be configured to move the anolyte through the anode chamber 108. Yet another pump may be in fluid connection with the cathode chamber 104 through the oxygen containing gas input 128 and the oxygen containing gas output 130 and may be configured to move the oxygen containing gas through the cathode chamber 104. In some embodiments, the pumps in fluid connection with the electrolyte chamber 106 and the anode chamber 108 may be peristaltic pumps and the pump in fluid connection with the cathode chamber 104 may be a gear pump.

The recirculation vessel 112 may be in fluid connection with the leaching reactor 114 and the electrolyte chamber 106 of the first electrochemical cell 102 and may be used to contain the hydrogen peroxide-enriched electrolyte 122 from the electrolyte chamber 106 before it enters the leaching reactor 114. A separate recirculation vessel (not shown) may be in fluid connection with the anode chamber 108 of the first electrochemical cell 102 and may be used to contain the anolyte from the anode chamber 108. The presence of the recirculation vessels in the electrochemical leaching system 100 may be optional. Thus, in some embodiments, the recirculation vessel 112 may not be present and the first electrochemical cell 102 may be in direct fluid connection with the leaching reactor 114, without the need to contain the hydrogen peroxide-enriched electrolyte 122 before it enters the leaching reactor 114.

With continued reference to FIG. 1, the leaching reactor 114 may be a container configured to contain electronic waste, such as components of spent electronic devices or scrap from manufacturing the electronic devices. The electronic devices may include, but are not limited to, solar panels, cell phones, printed circuit boards, laptop computers, desktop computers, televisions, etc. The spent electronic devices may include semiconductor materials, glass, polymer materials, and/or laminate materials, in addition to one or more metals of interest to be recovered. The spent electronic devices may be processed into small pieces (e.g., fragments), which are referred to herein as comminuted (e.g., fragmented) electronic waste, by conventional techniques, such as shredding, milling, crushing, etc. In some embodiments, the leaching reactor 114 may be a column in which the fragmented electronic waste is contained. During the metal recovery process, the fragmented electronic waste in the leaching reactor 114 may be exposed to the hydrogen peroxide-enriched electrolyte 122 from the recirculation vessel 112 that includes an oxidizer formulated to dissolve at least one metal of interest within the fragmented electronic waste to form the metal-enriched electrolyte 124. In other embodiments, the leaching reactor 114 may contain other fragmented metal containing materials instead of the fragmented electronic waste. The fragmented metal containing material may include, for example, an ore concentrate from which metals, such as gold, silver, uranium, copper, cobalt, nickel, or others, may be dissolved using the hydrogen peroxide-enriched electrolyte 122.

The electrochemical leaching system 100 may optionally include the second electrochemical cell 120, which is used to recover solubilized metals of interest present in the metal-enriched electrolyte 124 after the metal-enriched electrolyte 124 leaves the leaching reactor 114. Metals of interest may include, for example, tellurium (Te), cadmium (Cd), iron (Fc), nickel (Ni), cobalt (Co), selenium (Se), aluminum (Al), zinc (Zn), copper (Cu), lead (Pb), and tin (Sn).

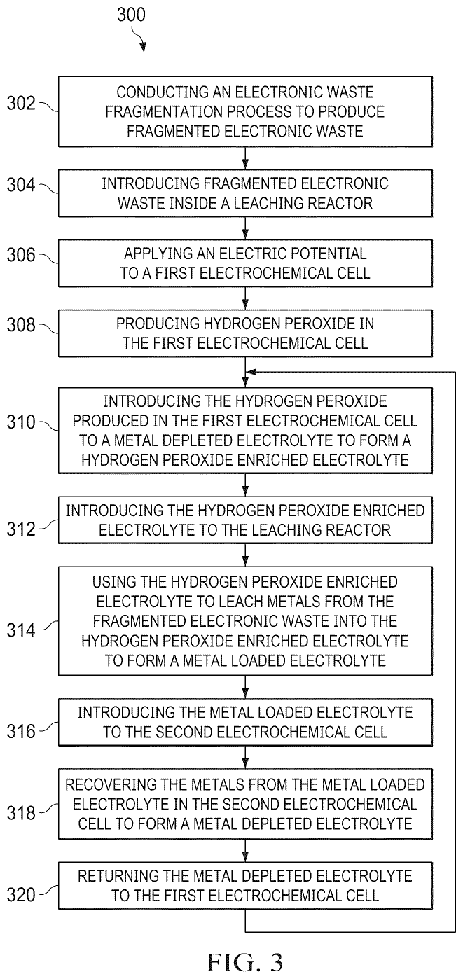

FIG. 3 is a simplified flow diagram illustrating a method 300 of recovering metals of interest from electronic waste. The method 300 includes conducting an electronic waste comminuted (e.g., fragmentation) process in act 302 that may include shredding or otherwise processing the electronic waste (e.g., solar panels, cell phones, printed circuit boards, laptop computers, desktop computers, televisions, etc.) into smaller pieces. The electronic waste may include photovoltaic (CdTe) solar panels that are shredded into particles ranging in size from about 75 μm to about 8 mm. The spent electronic devices may include semiconductor materials, glass, polymer materials, and/or laminate materials, in addition to the metal(s) of interest to be recovered. The metals of interest in the electronic waste may include, but are not limited to, cadmium and tellurium as major constituents (greater than 1000 ppm), 2) Fe, Se, and Al as minor constituents (˜50-300 ppm), and 3) Zn, Cu, Pb, and Sn as trace constituents (˜<1-10 ppm). However, other metals of interest may be present in the electronic waste. Using smaller solar panel particles resulting from the fragmentation process may provide a higher overall surface area that may lead to faster leaching of metals of interest that uses less kinetic energy. On the other hand, larger solar panel particles may provide a lower overall surface area that may lead to slower leaching of metals of interest that uses more kinetic energy.

The fragmented electronic waste obtained from the electronic waste fragmentation process may be introduced into the leaching reactor 114 in act 304. The leaching reactor 114 may be a column packed with the fragmented electronic waste and having a pack density that is defined as the ratio of the weight of the fragmented electronic waste inside the packed column to the volume of hydrogen peroxide-enriched electrolyte 122 within the recirculation vessel 112 (if present). The pack density of the leaching reactor 114 may range from about 500 g/L to about 2000 g/L, such as from about 1000 g/L to about 1500 g/L, or from about 1200 g/L to about 1300 g/L.

An electric potential is applied to the first electrochemical cell 102 in act 306. The power supply 110 may be connected to the anode 116 and the cathode 118 of the first electrochemical cell 102 and may be configured to apply an electric current between the anode 116 and the cathode 118. The first electrochemical cell 102 may be operated at a current density of between about 5 mA/cm² and about 1,000 mA/cm², such as between about 5 mA/cm² and about 50 mA/cm², between about 50 mA/cm² and about 100 mA/cm², between about 100 mA/cm2 and about 500 mA/cm², or between about 500 mA/cm² and about 1,000 mA/cm².

Hydrogen peroxide is produced in the first electrochemical cell 102 in act 308 and the produced hydrogen peroxide is introduced to the metal-depleted electrolyte 126 to form a hydrogen peroxide-enriched electrolyte 122 in act 308. In the first electrochemical cell 102, the cathode chamber 104 may contain an oxygen containing gas, the electrolyte chamber 106 may contain an aqueous acidic sulfate electrolyte that is formulated to function as the catholyte, and the anode chamber 108 may contain an aqueous base that is formulated to function as the anolyte. The anode 116 in the anode chamber 108 may facilitate the oxidation of water, obtained from the aqueous base in the anode chamber 108, to produce oxygen (O₂) according to the following reaction in an alkaline basic environment:

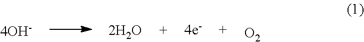

Water oxidation may also be achieved from an aqueous acid anolyte in the anode chamber 108, to produce oxygen (O₂) according to the following reaction:

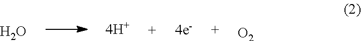

Substantially simultaneously, the gas diffusion electrode 202 between the cathode chamber 104 and the electrolyte chamber 106 may act as the cathode 118 and may facilitate the reduction of oxygen to generate hydrogen peroxide (e.g., H₂O₂). The oxygen to be reduced by the cathode 118 may be obtained from the oxygen containing gas in the cathode chamber 104, as well as the oxygen produced by the water reduction reaction occurring in the anode 116. The oxygen may be reduced at the cathode 118 through a two-electron oxygen reduction reaction as follows:

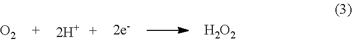

The water oxidation reaction at the anode 116 complements the oxygen reduction at the cathode 118, forming a reduction-oxidation reaction that maintains a balanced system in the first electrochemical cell 102. The hydrogen peroxide generated in the gas diffusion electrode 202 may eventually combine with the depleted electrolyte in the electrolyte chamber 106 to form a hydrogen peroxide-enriched electrolyte 122, and the hydrogen peroxide-enriched electrolyte 122 may be transported to the recirculation vessel 112 (if present) and, eventually, to the leaching reactor 114.

Applying the electric potential to the first electrochemical cell 102 allows the reduction-oxidation reaction to start such that the first electrochemical cell 102 produces hydrogen peroxide incrementally. Thus, the amount of hydrogen peroxide produced at the instant the electric potential is applied may be minimal. Furthermore, since leaching in the leaching reactor 114 depends on the presence of hydrogen peroxide in the hydrogen peroxide-enriched electrolyte 122, leaching of the metals of interest at the instant the electric potential is applied is also minimal. However, with time, the amount of hydrogen peroxide produced increases and stabilizes, making leaching of the metals of interest possible.

The gas diffusion electrode 202 (e.g., cathode 118) may comprise a carbon-based substrate and a carbon-based catalyst layer. Alternatively, the catalyst layer may be metal-based instead of carbon-based, or may be made of other suitable materials that are not substantially corroded by the electrolyte. If the catalyst layer is metal-based, the catalyst layer may include, for example, platinum, iron, cobalt, manganese, silver, nickel, stainless steel, ruthenium, rhodium, iridium, or alloys thereof. The anode 116 may include, for example, stainless steel, nickel, cobalt, manganese or other suitable materials that are not substantially corroded by the anolyte.

The oxygen containing gas in the cathode chamber 104 may include, for example, oxygen or air. The acid in the aqueous acidic sulfate electrolyte in the electrolyte chamber 106 may include sulfuric acid, nitric acid, hydrochloric acid, perchloric acid, or a combination thereof. By way of nonlimiting example, the concentration of the acid may be from about 0.1 molar (M) to about 4 M, such as from about 0.1 M to about 1 M, or from about 0.2 M to about 0.6 M. In some embodiments, the acid is sulfuric acid and is present in the aqueous acidic sulfate electrolyte at about 0.5 M. The sulfate in the aqueous acidic sulfate electrolyte in the electrolyte chamber 106 may include potassium sulfate, sodium sulfate, ammonium sulfate, or a combination thereof. By way of nonlimiting example, the concentration of the sulfate may be from about 0.1 M to about 1 M, such as from about 0.2 M to about 0.8 M, or from about 0.4 M to about 0.6 M. In some embodiments, the sulfate is sodium sulfate and is present in the aqueous acidic sulfate electrolyte at about 0.5 M. The aqueous base in the anode chamber 108 may include potassium hydroxide, sodium hydroxide, lithium hydroxide, calcium hydroxide, ammonium hydroxide, or a combination thereof. By way of nonlimiting example, the concentration of the aqueous base may be from about 0.1 M to about 4 M, such as from about 0.5 M to about 2 M, or from about 0.75 M to about 1.25 M. In some embodiments, the aqueous base is sodium hydroxide and is present in the aqueous acidic sulfate electrolyte at about 1 M.

After the hydrogen peroxide-enriched electrolyte 122 exits the first electrochemical cell 102, the hydrogen peroxide-enriched electrolyte 122 may be introduced to the leaching reactor 114 in act 312. The hydrogen peroxide-enriched electrolyte 122 may be introduced to the recirculation vessel 112 (if present) to be stored before being introduced to the leaching reactor 114. The hydrogen peroxide-enriched electrolyte 122 may be moved from the first electrochemical cell 102 to the recirculation vessel 112 and from the recirculation vessel 112 to the leaching reactor 114 with one of the pumps previously mentioned.

The metals of interest are leached from the fragmented electronic waste into the hydrogen peroxide-enriched electrolyte 122 to form a metal-enriched electrolyte 124 in act 314. Leaching involves exposing the fragmented electronic waste inside the leaching reactor 114 to the hydrogen peroxide-enriched electrolyte 122 comprising the oxidizer (e.g., hydrogen peroxide), and dissolving at least one metal of interest from the fragmented electronic waste into the hydrogen peroxide-enriched electrolyte 122. The solubilized metals of interest produced during leaching may be present in a precipitated solid phase or an aqueous solution phase. Concentrations of the solubilized metals of interest may depend on pH and concentrations of metals of interest, hydrogen peroxide, and acid used in the leaching reactor 114. In some embodiments, the hydrogen peroxide-enriched electrolyte 122 may include sulfuric acid and sodium sulfate in addition to hydrogen peroxide, and may be used to leach Cd and Te from shredded solar panels and into the aqueous solution phase. The Cd and Te may be dissolved, according to the following reactions:

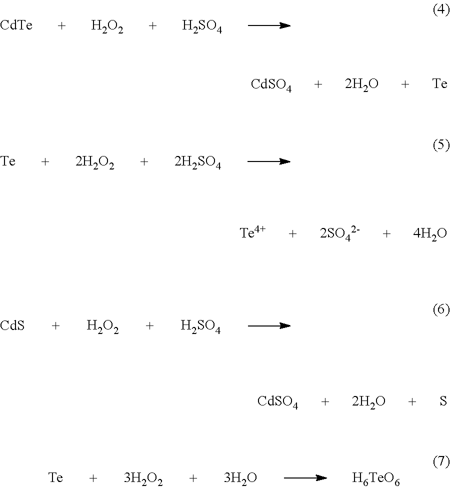

The hydrogen peroxide may oxidize the Cd and Te in the shredded solar panels to Te⁴⁺ and Cd²⁺ in the aqueous solution phase.

The production rate of hydrogen peroxide in the first electrochemical cell 102 and leaching efficiency in the leaching reactor 114 may depend on a multitude of factors. Given that the hydrogen peroxide serves as the oxidizer during the leaching of the metals of interest, leaching efficiency may be proportional to the concentration of hydrogen peroxide in the hydrogen peroxide-enriched electrolyte 122. Thus, a higher hydrogen peroxide concentration may increase leaching efficiency and, conversely, a lower hydrogen peroxide concentration may decrease leaching efficiency. The production rate of hydrogen peroxide and leaching efficiency may depend on, for example, the current being applied on the first electrochemical cell 102. A higher applied current may increase hydrogen peroxide production and leaching efficiency, conversely, a lower applied current may decrease hydrogen peroxide production and leaching efficiency. In some instances, the applied current is 1 A. The production rate of hydrogen peroxide and leaching efficiency may also depend on the flow rate and composition of the oxygen containing gas. A higher flow rate and a higher oxygen content in the oxygen containing gas may increase hydrogen peroxide production and leaching efficiency, conversely, a lower flow rate and a lower oxygen content in the oxygen containing gas may decrease hydrogen peroxide production and leaching efficiency. In some instances, the flow rate of the oxygen containing gas is 25 sccm and the oxygen containing gas is oxygen gas. The production rate of hydrogen peroxide and leaching efficiency may also depend on the leaching time. A higher leaching time may increase hydrogen peroxide production and leaching efficiency, conversely, a lower leaching time may decrease hydrogen peroxide production and leaching efficiency. In some instances, the leaching time is 3 hours.

The metal-enriched electrolyte 124 may be introduced to the second electrochemical cell 120 in act 316. The metal-enriched electrolyte 124 may be moved from the leaching reactor 114 to the second electrochemical cell 120 with one of the pumps previously mentioned.

Metals of interest are recovered from the metal-enriched electrolyte 124 in in the second electrochemical cell 120 to form the metal-depleted electrolyte 126 in act 318. After the hydrogen peroxide-enriched electrolyte 122 passes through the leaching reactor 114, the hydrogen peroxide in the hydrogen peroxide-enriched electrolyte 122 may be depleted since it is used as the oxidizer during leaching. The metals of interest in the fragmented electronic waste may dissolve into the electrolyte to produce an electrolyte containing the solubilized metal ions (e.g., Te⁴⁺ and Cd²⁺), or metal-enriched electrolyte 124. The solubilized metals of interest may be recovered from the metal-enriched electrolyte 124 through either electrowinning or electroplating in a recovery electrochemical cell 400, such as the second electrochemical cell 120. Chemical methods, such as ion exchange or co-precipitation, may be used to recover one or more of the solubilized metals of interest instead of or in addition to the electrochemical methods of recovery.

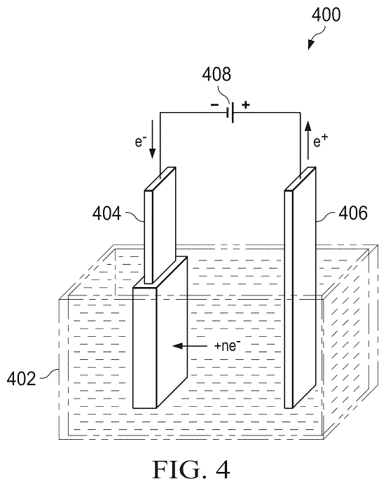

FIG. 4 is a recovery electrochemical cell 400, corresponding to the second electrochemical cell 120 in FIG. 1, used for electrowinning or electroplating the metals of interest from the metal-enriched electrolyte 124. The recovery electrochemical cell 400 may include an electrolyte 402, a cathode 404, an anode 406, and a power supply 408. The electrolyte 402 may include the metal-enriched electrolyte 124 produced as an output of the leaching reactor 114. The cathode 404 may be formed of and include, for example, a carbon-based material, stainless steel, platinum, gold, copper or titanium. In some embodiments, the cathode 404 is formed of and includes titanium. The anode 406 may be formed of and include, for example, a platinum or titanium substrate that may include a coating of RuO₂, IrO₂, TaO₂, or TiO₂ to provide stability and oxidation resistance to the substrate in the acidic environment of the electrolyte 402. In some embodiments, the anode is formed of and includes IrO₂ covered titanium.

In the recovery electrochemical cell 400, the power supply 408 may be connected to the anode 406 and the cathode 404 and configured to apply an electric potential to the recovery electrochemical cell 400. The cathode 404 may serve as a non-reactive substrate for deposition of the one or more metals of interest from the metal-enriched electrolyte 124. The electric potential applied to the recovery electrochemical cell 400 may reduce the solubilized metal ions in the electrolyte 402, allowing the reduced metal ions to be deposited on the cathode 404. For example, when the solubilized metal ions are Te⁴⁺ and Cd²⁺, the metal ions may be reduced to Te⁰ and Cd⁰ according to the reactions:

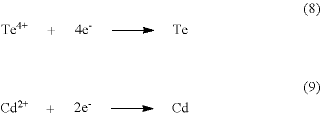

The electrolyte exiting the recovery electrochemical cell 400 may be depleted of hydrogen peroxide, due to act 314, and depleted of solubilized metal ions, due to act 318, forming the metal-depleted electrolyte 126.

Te⁰ and Ce⁰ recovery rates in the second electrochemical cell 120 may depend on a multitude of factors. Te⁰ and Ce⁰ recovery rates may depend, for example, on the cathodic reduction potential of the second electrochemical cell 120. The Te⁰ recovery yield may be higher at a lower cathodic reduction potential while Ce⁰ recovery yield may be higher at a higher cathodic reduction potential. In some instances, the cathodic reduction potential is −400 mV for Te⁰ recovery, while the cathodic reduction potential is −800 mV for Ce⁰ recovery. The Te⁰ and Ce⁰ recovery rates may also depend, for example, on electrowinning or electrodeposition time. The Te⁰ and Ce⁰ recovery yields may be higher with a higher electrowinning or electrodeposition time. In some instances, the electrowinning or electrodeposition time is about 3 hours.

The metal-depleted electrolyte 126 is returned to the first electrochemical cell 102 in act 320. Once in the first electrochemical cell 102, the metal-depleted electrolyte 126 may be replenished by a fresh supply of hydrogen peroxide obtained from the first electrochemical cell 102 to form a hydrogen peroxide-enriched electrolyte 122 (e.g., act 310). The hydrogen peroxide-enriched electrolyte 122 may be utilized again (e.g., recycled) for leaching of metals of interest in the leaching reactor 114 (e.g., act 314) and the solubilized metals of interest can again be recovered from the resulting metal-enriched electrolyte 124 in the second electrochemical cell 120 (e.g., act 318). By conducting acts 308, 310, 312, and 314 repeatedly, a cyclical process may be achieved where the hydrogen peroxide in the electrolyte is repeatedly depleted and replenished to continuously leach the metals of interest from the fragmented electronic waste.

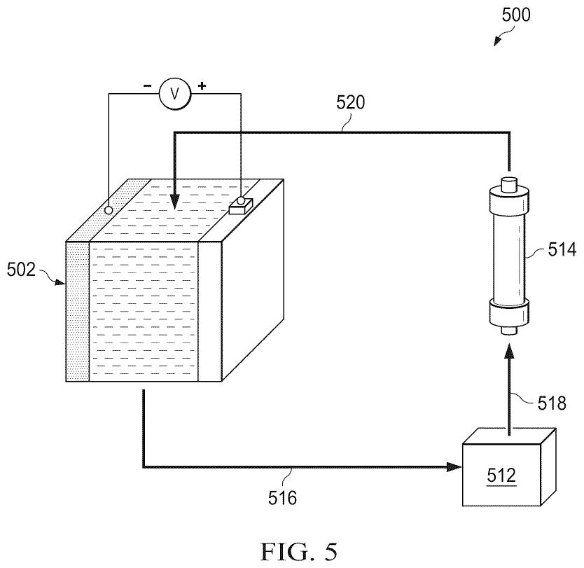

The recovery electrochemical cell 400 may be integrated into the flow path of the overall electrochemical leaching system. In other words, the recovery electrochemical cell 400 may be a part of the chemical process loop. If the recovery electrochemical cell 400 is part of the chemical process loop, the recovery electrochemical cell 400 may be placed after the leaching reactor 114, as shown by second electrochemical cell 120 in FIG. 1, or the recovery electrochemical cell 400 may be placed before the leaching reactor 114. If the recovery electrochemical cell 400 is placed before the leaching reactor 114, the integrated recovery electrochemical cell 400 may also work as the recirculation vessel 112, as shown by recirculation electrochemical cell 512 in FIG. 5. In other embodiments, the recovery electrochemical cell 400 may not be part of the chemical process loop in that the recovery electrochemical cell 400 is external to the electrochemical leaching system 100. The recovery of the metals of interest from the electrolyte may happen in a separate container that is not in fluid communication with any of the process units of the electrochemical leaching system, as explained in method 800.

FIG. 5 is an electrochemical leaching system 500 for a metal recovery process, in accordance with embodiments of the disclosure where the recovery electrochemical cell is positioned before the leaching reactor. The electrochemical leaching system 500 is similar to electrochemical leaching system 100, with the difference being that, in electrochemical leaching system 500, holding and accumulation of electrolyte as well as recovery of metals of interest from the electrolyte may occur in the recirculation electrochemical cell 512 rather than in the recirculation vessel 112 and second electrochemical cell 120, respectively. The recirculation electrochemical cell 512 is in fluid connection with the first electrochemical cell 502 and the leaching reactor 514, with the recirculation electrochemical cell 512 being configured to act as a recirculation vessel. Thus, the electrochemical leaching system 500 may include a first electrochemical cell 502, a recirculation electrochemical cell 512, and a leaching reactor 514, with all three process units being in a chemical process loop.

The electrolyte in the first electrochemical cell 502 may flow throughout the different process units in the electrochemical leaching system 500 and may experience changes in material composition as it enters and exits the different process units. For example, the electrolyte may enter the first electrochemical cell 502 as a metal-enriched electrolyte 520 and exit as a hydrogen peroxide-enriched electrolyte 516. The hydrogen peroxide-enriched electrolyte 516 may enter the recirculation electrochemical cell 512 and exit as a metal-depleted electrolyte 518. The metal-depleted electrolyte 518 may enter the leaching reactor 514 and exit as a metal-enriched electrolyte 520. The metals of interest may be recovered from the metal-enriched electrolyte 520 as previously described for the electrochemical leaching system 100.

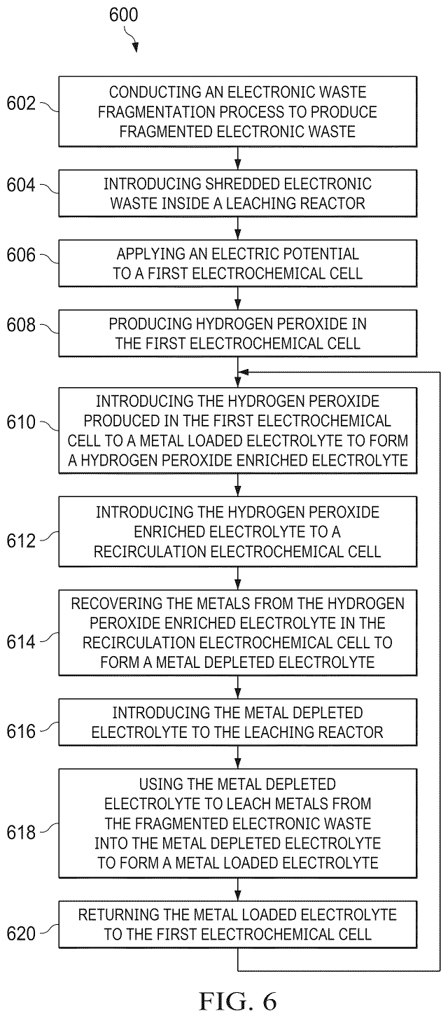

FIG. 6 is a simplified flow diagram illustrating a method 600 of recovering metals of interest from electronic waste, in accordance with embodiments of the disclosure where the recirculation electrochemical cell 512 is directly integrated into the main flow path of the overall electrochemical leaching system 500 and is placed before the leaching reactor 114. Method 600 is similar to method 300, with the difference being that, in method 600, the recovery of solubilized metals of interest from the electrolyte solution happens before the leaching reactor 114 rather than after the leaching reactor 114. Thus, method 600 proceeds by conducting an electronic waste fragmentation process in act 602, the fragmented electronic waste is placed inside the leaching reactor 514 in act 604, an electronic potential is applied to a first electrochemical cell 502 in act 606, hydrogen peroxide is produced in the first electrochemical cell 502 to form a hydrogen peroxide-enriched electrolyte 516 in acts 608 and 610. The hydrogen peroxide-enriched electrolyte 516 is introduced into the recirculation electrochemical cell 512 in act 612, and metals of interest are recovered from the hydrogen peroxide-enriched electrolyte 516 to form a metal-depleted electrolyte 518 in act 614. The metal-depleted electrolyte 518 is introduced to the leaching reactor 514 in act 616, and the metals of interest are leached from the metal-depleted electrolyte 518 to form a metal-enriched electrolyte 520 in act 618. The metal-enriched electrolyte 520 is then recycled to the first electrochemical cell 502 in act 620.

After the metal-enriched electrolyte 520 is in the first electrochemical cell 502, the metal-enriched electrolyte 520 may be replenished with a fresh supply of hydrogen peroxide obtained from the first electrochemical cell 502 to form a hydrogen peroxide-enriched electrolyte 516 (e.g., act 610). Thus, acts 610, 612, 614, 616, 618, and 620 can form a cyclical process where the hydrogen peroxide in the electrolyte is repeatedly depleted and replenished to continuously leach the metals of interest from the fragmented electronic waste.

FIG. 7 is an electrochemical leaching system 700 for a metal recovery process, in accordance with embodiments of the disclosure where a recovery electrochemical cell may be separate from the electrochemical leaching system 700. Electrochemical leaching system 700 is similar to electrochemical leaching system 100, with the difference being that, in electrochemical leaching system 700, the recovery electrochemical cell may not be directly integrated into the main flow path of the overall electrochemical leaching system 700. Thus, the electrochemical leaching system 700 may include an electrochemical cell 702, a recirculation vessel 712 (if present), and a leaching reactor 714, with all three process units being in a chemical process loop.

The electrolyte in the electrochemical cell 702 may flow throughout the different process units in the electrochemical leaching system 700 and may experience changes in composition as it enters and exits the different process units. For example, the electrolyte may enter the electrochemical cell 702 as a metal-enriched electrolyte 718 and exit as a hydrogen peroxide-enriched electrolyte 716. Conversely, the electrolyte may enter the leaching reactor 714 as a hydrogen peroxide-enriched electrolyte 716 and exit as a metal-enriched electrolyte 718.

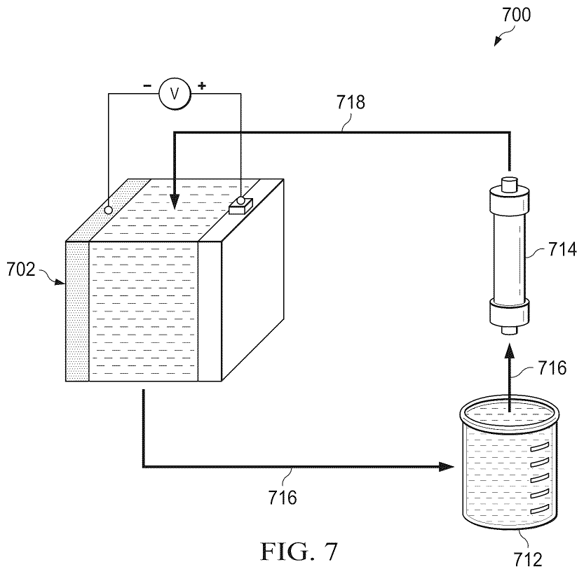

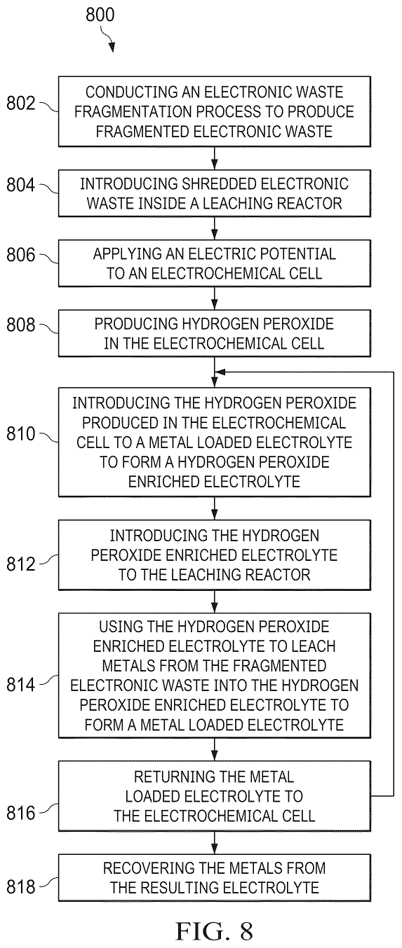

FIG. 8 is a simplified flow diagram illustrating a method 800 of recovering metals of interest from electronic waste, in accordance with embodiments of the disclosure where the recovery electrochemical cell may be separate from the electrochemical leaching system 700. Thus, method 800 proceeds by conducting an electronic waste fragmentation process in act 802, the fragmented electronic waste is placed inside the leaching reactor 714 in act 804, an electronic potential is applied to an electrochemical cell 702 in act 806, hydrogen peroxide is produced in the electrochemical cell 702 to form a hydrogen peroxide-enriched electrolyte 716 in acts 808 and 810, the hydrogen peroxide-enriched electrolyte 716 is introduced into the leaching reactor 714 and used to leach metals of interest from the fragmented electronic waste to form a metal-enriched electrolyte 718 in acts 812 and 814, and the metal-enriched electrolyte 718 is returned to electrochemical cell 702 in act 816.

After the metal-enriched electrolyte 718 is in the electrochemical cell 702, the metal-enriched electrolyte 718 may be replenished by a fresh supply of hydrogen peroxide obtained from electrochemical cell 702 to form a hydrogen peroxide-enriched electrolyte 716 (e.g., act 810). Thus, acts 810, 812, 814, and 816, can form a cyclical process where the hydrogen peroxide in the electrolyte is repeatedly depleted and replenished to continuously leach the metals of interest from the fragmented electronic waste. However, in method 800, act 818 for recovering the metals of interest form the resulting electrolyte is not part of the cyclical process. Therefore, rather than the solubilized metals of interest being recovered from the electrolyte continuously as part of the cyclical process (as seen in method 300 and method 600), the metals of interest are allowed to accumulate in the electrolyte during the cyclical process and, only after conducting the cyclical process, are the solubilized metals of interest recovered from the resulting electrolyte in a recovery electrochemical cell that may be outside (e.g., external to) the electrochemical leaching system 700.

Using an electrochemical cell for hydrogen peroxide production as part of an electrochemical leaching system, according to embodiments of the disclosure, may increase the yield of leached and recovered metals of interest and reduce the time needed for leaching.

Furthermore, given that the byproducts from leaching with hydrogen peroxide are water and oxygen, the use of hydrogen peroxide during leaching may result in byproducts that are better for the environment than those produced in conventional hydrometallurgical methods. The conventional hydrometallurgical processes also have a high carbon footprint. In addition, continuous production of the oxidizing agent, such as hydrogen peroxide, with the electrochemical cell may lead to reduced reagent usage when compared to conventional leaching based sacrificial use of that same oxidizing agent. Using less reagent also reduces transportation and storage costs for the reagent.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

### EXAMPLES

### Sieving Process

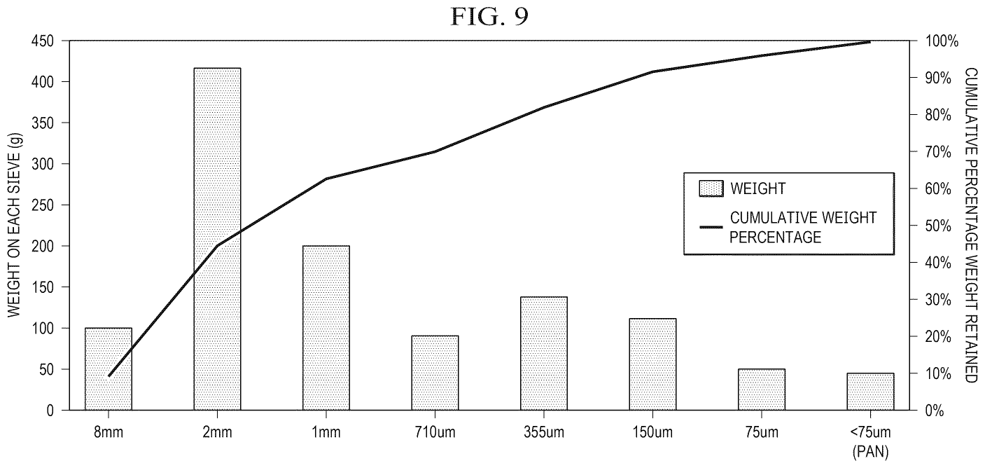

A sieving process was conducted based on ASTM Standard C136. Seven sieves were used to separate CdTe solar cell particles based on the particle size. The sieves were stacked from coarse to fine in the order of 8 mm, 2 mm, 1 mm, 710 μm, 355 μm, 150 μm, 75 um, and <75 μm. Total weight of the CdTe solar cell particles was 1156.0 g, and the particles were sieved in three batches with 399.7 g, 398.8 g, and 356.4 g, respectively. The sieving time was 30 minutes. After consolidating the results from each batch, total sieving results are shown in FIG. 9 and Table 1 below, where FIG. 9 is a graph comparing the weight on each sieve and the cumulative percentage weight retained based on sieve mesh size.

TABLE 1

| | Weight | Percentage | Cumulative | Cumulative |
|---|---|---|---|---|
| Sieve mesh | retained | of total | weight | percentage |
| size | (g) | weight | (g) | weight Retained |
| 8 mm | 100.7 | 8.7% | 100.7 | 9% |
| 2 mm | 418.1 | 36.2% | 518.8 | 45% |
| 1 mm | 201.5 | 17.4% | 720.3 | 62% |
| 710 μm | 90.8 | 7.9% | 811.1 | 70% |
| 355 μm | 137.4 | 11.9% | 948.5 | 82% |
| 150 μm | 111.1 | 9.6\hat{ } | 1059.6 | 92% |
| 75 μm | 50.5 | 4.4% | 1110.1 | 96% |
| <75 μm | 45.1 | 3.9% | 1155.2 | 100% |
| (pan) | | | | |

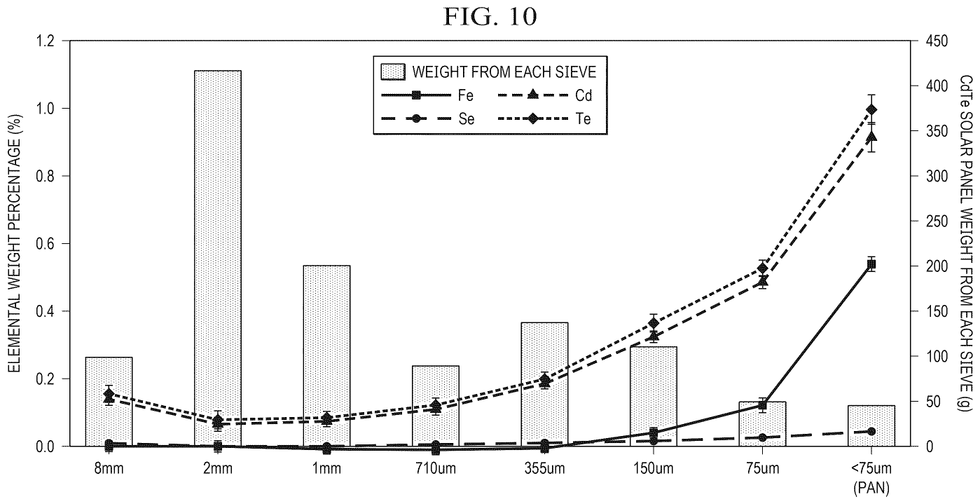

As shown by FIG. 9 and Table 1, a majority of the particles were retained on the 2 mm sieve, and 82% of particles had particle size larger than 355 μm. Sieved particles from each batch were digested in 50% HNO₃ in a microwave digestor and analyzed with inductively coupled plasma optical emission spectroscopy (ICP-OES) and inductively coupled plasma mass spectrometry (ICP-MS). FIG. 10 and Table 2 below show the correlation between wt % of the metals in each sieve and CdTe solar cell particle weight retained in each sieve. Furthermore, looking at FIG. 10 and Table 2, it can be ascertained that larger particles have lower concentrations of Cd and Te, and smaller particles have higher concentrations of Cd and Te.

TABLE 2

| | | | Per- | | | | |
|---|---|---|---|---|---|---|---|
| | | | cent- | | | | |
| | | Weight | age of | Cd | | Te | |
| Sieve | | retained | total | weight | Cd | weight | Te |
| size | | (g) | weight | (g) | wt % | (g) | wt % |
| 8 | mm | 100.7 | 8.7% | 0.148 | 0.146% | 0.156 | 0.154% |
| 2 | mm | 418.1 | 36.2% | 0.313 | 0.074% | 0.327 | 0.078% |
| 1 | mm | 201.5 | 17.4% | 0.153 | 0.075% | 0.167 | 0.082% |
| 710 | μm | 90.8 | 7.9% | 0.101 | 0.111% | 0.110 | 0.121% |
| 355 | μm | 137.4 | 11.9% | 0.256 | 0.186% | 0.279 | 0.203% |
| 150 | μm | 111.1 | 9.6% | 0.366 | 0.329% | 0.406 | 0.365% |
| 75 | μm | 50.5 | 4.4% | 0.247 | 0.489% | 0.264 | 0.522% |

| | | | | | | |
|---|---|---|---|---|---|---|
| <75 μm | 45.1 | 3.9% | 0.420 | 0.931% | 0.452 | 1.002% |
| (pan) | | | | | | |

H₂O₂ Chemical Leaching Compared to H₂O₂ Electrochemical Leaching

H₂O₂ Chemical leaching (without electrochemical generation of H₂O₂) experiments of CdTe photovoltaic (PV) solar cells were carried out to recover Cd and Te from end-of-life (EOL) CdTe photovoltaic (PV) cells. To understand the role of H₂O₂ in leaching efficiency, three experiments were conducted with increasing concentration of H₂O₂, while the H₂SO₄ concentration was fixed at 50 g/L (approximately 0.5 M) and the test duration and pack density maintained at 3 hours and 1250 g/L, respectively. The experimental matrix is shown below in Table 3 below:

TABLE 3

| | H₂O₂ | H₂SO₄ | Test | Pulp |
|---|---|---|---|---|
| Experiment | concentration | concentration | duration | density |
| No. | (g/L) | (g/L) | (hours) | (g/L) |
| 1 | 0 | 50 | 3 | 1250 |
| 2 | 10 | 50 | 3 | 1250 |
| 3 | 50 | 50 | 3 | 1250 |

The H₂O₂ Chemical leaching system was composed of a column that was filled with shredded CdTe solar cells with particle size ranging from <75 μm to 8 mm, based on sieving results. On average, 30 g of CdTe PV material was packed into the column. The leachate solution was recirculated from a reservoir through the column using a peristaltic pump. Flow direction was upflow so that better contact between the lixiviant and the solids may occur.

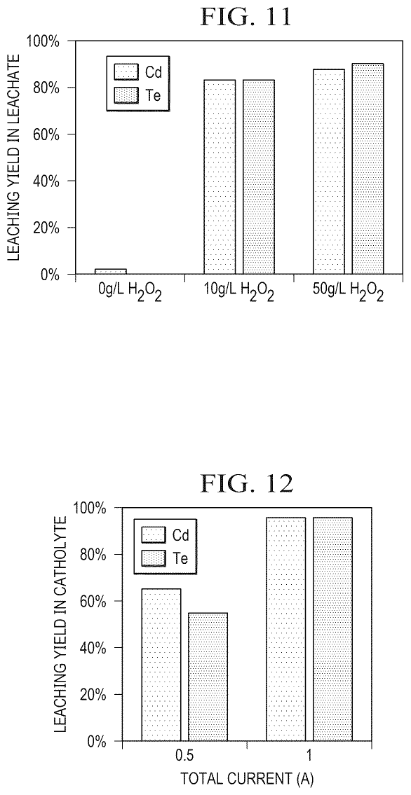

The results for leaching yield (based on Eq. 9 below) are shown in FIG. 11. FIG. 11 shows the leaching yields of Cd and Te at varying values for H₂O₂ concentration. The leachate was analyzed by Atomic Absorption Spectroscopy (AAS) for Cd and ICP-MS for Te. Results in FIG. 11 clearly show the importance of H₂O₂ for Cd and Te leaching yields. When no H₂O₂ is present, minimal Cd (2.00%) and Te (0.17%) were leached and the majority of the two metals stayed in the residual glass. Using a H₂O₂ concentration of 10 g/L resulted in a leaching yield of 84% for Cd and a leaching yield of 83% for Te, and using a H₂O₂ concentration of 50 g/L resulted in a leaching yield of 88% for Cd and a leaching yield of 90% for Te.

$$Leaching yield ( \% ) = \frac{m ( leachate )}{m ( leachate ) + m ( undissolved )} \qquad ( 10 )$$

These H₂O₂ chemical leaching experiments were followed by H₂O₂ electrochemical leaching experiments. An electrochemical leaching system (similar to the electrochemical leaching system in FIG. 7) was composed of a leaching reactor 714 (e.g., packed column) that was filled with shredded CdTe PV material with particle size ranging from <75 μm to 8 mm, based on sieving results. The test duration was 3 hours and the pack density of the leaching reactor 714 was 1250 g/L. On average, 30 g of CdTe cells were packed into the leaching reactor 714. The leachate solution was recirculated from a recirculation vessel 712 through the leaching reactor 714 using a peristaltic pump. Electrochemical H₂O₂ generation was carried out in 50 g/L H₂SO₄. To introduce the H₂O₂ into the system, a flow-through electrochemical cell 702 was located between the recirculation vessel 712 and the leaching reactor 714. The electrochemical cell 702 included three components: a cathode chamber 104 filled with pure O₂ with a flow rate of approximately 17 standard cubic meter per minute (sccm), an electrolyte chamber 106 with 0.5 M Na₂SO₄ and H₂SO₄, and an anode chamber 108 with recirculating 1 M NaOH.

The O₂ generated at the anode chamber 108 was used for the H₂O₂ production reaction at the cathode 118. The H₂O₂ production process also included using the O₂ from the anode chamber 108 in the cathode 118.

The cathode chamber 104 and the electrolyte chamber 106 are separated by a carbon-based gas diffusion electrode 202, which acts as the cathode 118 for O₂ reduction to generate H₂O₂. Subsequently, the electrolyte with the electrochemically generated H₂O₂ is recirculated through the leaching reactor 714 via a peristaltic pump to leach Cd and Te. The electrolyte chamber 106 and anode chamber 108 are separated with a bipolar membrane 1318, which ensures the ionic conductivity between the anolyte and catholyte and the anodic reaction is water oxidation which generates O₂.

Leaching experiments were performed varying the current density applied to the electrochemical cell 702 as shown in Table 4 below. Leaching results are shown in FIG. 12. FIG. 12 shows the leaching yields of Cd and Te at varying values for total current. Leaching with an applied current of 0.5 A current resulted in a leaching yield of 66% for Cd and a leaching yield of 55% for Te. On the other hand, leaching with an applied current of 1 A current resulted in a leaching yield of 96% for both Cd and Te. Leaching at 1 A was repeated and showed a leaching yield of 98% for Cd, which was close to the previous test's 96% leaching yield for Cd.

TABLE 4

| Experiment | Total current | Catholyte | | Anolyte | Test duration |
|---|---|---|---|---|---|
| No. | (A) | Na₂SO₄ | H₂SO₄ | NaOH | (hours) |
| 4 | 0.5 | 0.5 | 0.5 | 1 | 3 |
| 5 | 1 | 0.5 | 0.5 | 1 | 3 |

Overall, the H₂O₂ electrochemical leaching experiments showed better leaching yields than H₂O₂ chemical leaching with 50 g/L H₂O₂. This was primarily due to the rapid H₂O₂ production rate and slow H₂O₂ consumption rate during CdTe leaching.

### Electrochemical Leaching System

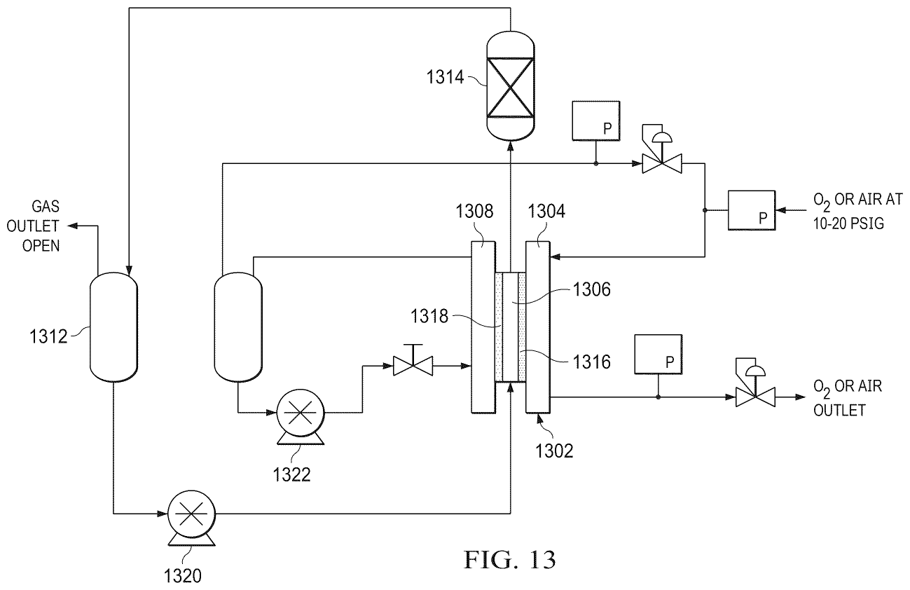

FIG. 13 represents a flowsheet of an electrochemical leaching system for the electrochemically generated (EC-generated) hydrogen peroxide (H₂O₂) leaching process for Cd and Te recovery from EOL CdTe thin film PV material. The electrochemical leaching system included a leaching reactor 1314 that contained shredded EOL CdTe PV solar panels, in which the material size of the shredded solar panels ranged from <75 μm to 8 mm. The flow electrochemical cell 1302 included three components: 1) a gas-flowable (via gear pump) cathode chamber 1304 filled with pure O₂ (or air) from a gas tank at a flow rate of up to 25 sccm, 2) a liquid-flowable (via peristaltic pump 1320) electrolyte chambers 1306 with recirculating aqueous solution of 0.5 M Na₂SO₄ and 0.5 M H₂SO₄, and 3) a liquid-flowable (via peristaltic pump 1322) anode chamber 1308 with recirculating 1 M aqueous KOH. The gas-flowable cathode chamber 1304 and the liquid-flowable acidic electrolyte chamber 1306 were separated by a carbon-based gas diffusion electrode 1316 which acted as the cathode for electrochemical O₂ reduction to generate H₂O₂. In this electrochemical leaching system, the aqueous mixture of the acidic electrolyte and the EC-generated H₂O₂ acted as the leachate and was recirculated (via peristaltic pump 1320) through the leaching reactor 1314 containing the CdTe PV material to leach Cd and Te. The aqueous leachate was continuously recirculated from a recirculation vessel 1312 through the leaching reactor 1314. The anode chamber 1308 produced O₂ via electrochemical (EC) oxidation of water. The acidic electrolyte solution in the electrolyte chambers 1306 and the alkaline anolyte solution in the anode chamber 1308 were separated with a bipolar membrane 1318, which ensured the ionic conductivity between the anolyte and catholyte and facilitates EC water oxidation in the anode chamber 1308 to produce O₂. The EC-generated O₂, with a flow rate of up to 4 sccm, was redirected to mix with the O₂ (or air) that was supplied to the gas-flowable cathode chamber 1304 from the gas tank. In other words, the gas-flowable cathode chamber 1304, used for EC-generated H₂O₂, operated with a combination of O₂ (or air) supplied from the gas tank and EC-generated O₂ supplied from the anodic anode chamber 1308.

The electrochemical leaching system was used in leaching experiments on 30 g of CdTe PV material with EC-generated H₂O₂ leaching. The experiments were carried out at 25° C. with a pack density of 1250 g/L. The concentrations of Cd and Te in the leachate and the residual solid (digested in 50% HNO₃ for 24 hours) were analytically determined with Atomic Absorption Spectroscopy (AAS) and ICP-MS. The leaching efficiency (%) was calculated as a ratio of the total amount of the metal in the leachate and the total amount of metal in the leachate plus the residual solids. The impacts of three key process parameters on the leaching efficiencies of Cd and Te to optimize the EC-generated H₂O₂ leaching process were studied. The three key process parameters included: 1) applied current (maximum of 1 A), 2) feed gas composition (i.e., O₂ or air) and gas flow rate (maximum of 25 sccm), and 3) leaching time (maximum of 3 hours).

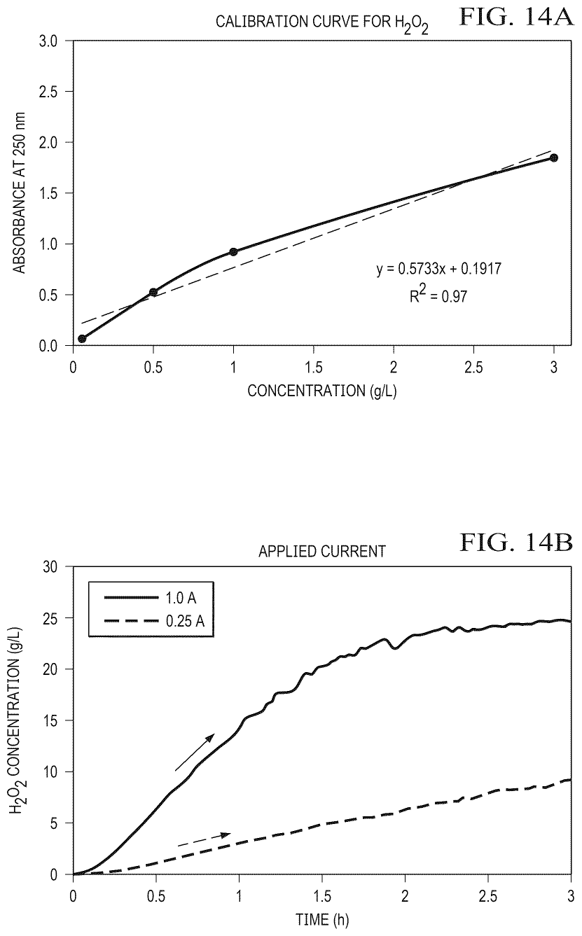

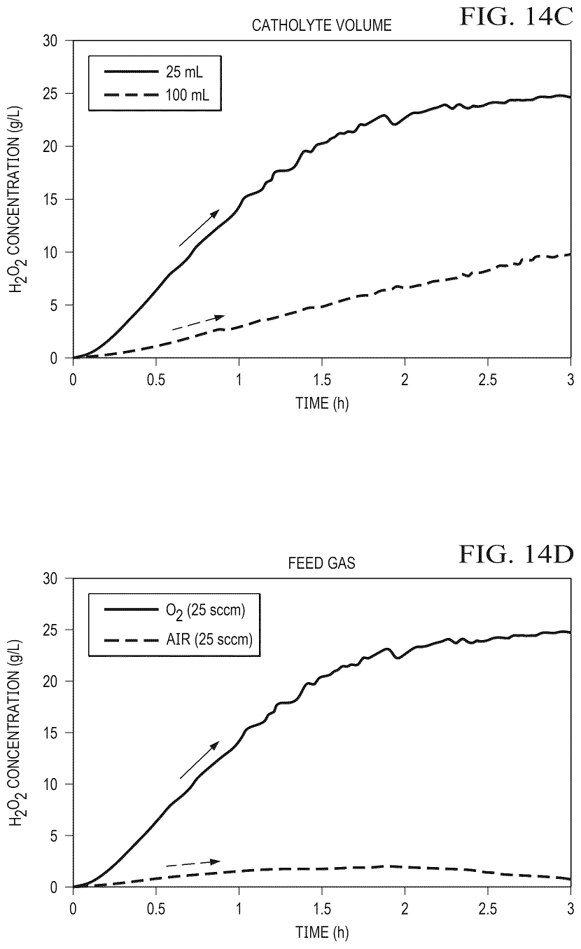

EC Generation of H₂O₂—Before investigating the EC-generated H₂O₂ leaching process, insights were obtained of the process of H₂O₂ production via cathodic reduction of O₂ in this system at 25° C. without any CdTe PV material present in the leaching reactor 1314. In this experiment, the mixed aqueous solution of the acidic electrolyte and the EC-generated H₂O₂ was continuously recirculated via a flow-through UV-vis absorption spectrometer system that allowed in-situ recording of the ground-state electronic absorption of H₂O₂ (λₘₐₓ=250 nm) as functions of time (hours; h) and applied current (ampere; A). The spectral absorbance of H₂O₂ was converted to H₂O₂ concentration (grams per liter; g/L) based on a calibration curve (i.e., linear regression) developed via Beer-Lambert law by using standard H₂O₂ solutions of known concentrations, as seen in FIG. 14A. The graphs in FIG. 14B, FIG. 14C, and FIG. 14D show the impact of different process parameters, such as applied current, catholyte volume, and feed gas, on the efficiency of EC generation of H₂O₂.

Impact of Applied Current on EC Generation of H₂O₂—FIG. 14B is a graph that shows the relationship between time and H₂O₂ concentration at varying values for applied current that shows the impact of applied current on EC-generated H₂O₂. For a current of 0.25 A, the concentration of EC-generated H₂O₂ (based on spectral absorption data) increased with time and reached a steady-state value of 10 g/L over 3 hours. However, upon applying 1 A of current, the EC-generated H₂O₂ concentration further increased to reach a steady-state value of 25 g/L. Therefore, this data proves that increasing the applied current increases the EC H₂O₂ production rate via cathodic reduction of O₂.

Impact of Catholyte Volume on EC Generation of H₂O₂—FIG. 14C is a graph that shows the relationship between time and H₂O₂ concentration at varying values for catholyte volume that shows the impact of catholyte volume on EC-generated H₂O₂. A catholyte volume of 25 milliliter (mL) leads to a steady-state H₂O₂ concentration of 25 g/L, and a catholyte volume of 100 mL leads to a steady-state H₂O₂ concentration of 10 g/L. Therefore, this data shows that the produced H₂O₂ gets dilute when a higher volume of electrolyte is taken.

Impact of Feed Gas Composition on EC Generation of H₂O₂—FIG. 14D is a graph that shows the relationship between time and H₂O₂ concentration while using pure oxygen and air as a feed gas that shows the impact of feed gas composition on EC-generated H₂O₂. Under the same flow rate of 25 sccm, steady-state H₂O₂ concentration was 25 g/L when pure O₂ was used the feed gas. In contrast, the steady-state H₂O₂ concentration was significantly lower, at ˜2 g/L, when air was used as the feed gas instead of pure O₂. This confirms that EC-generation of H₂O₂ is dependent on the concentration of O₂ on the feed gas.

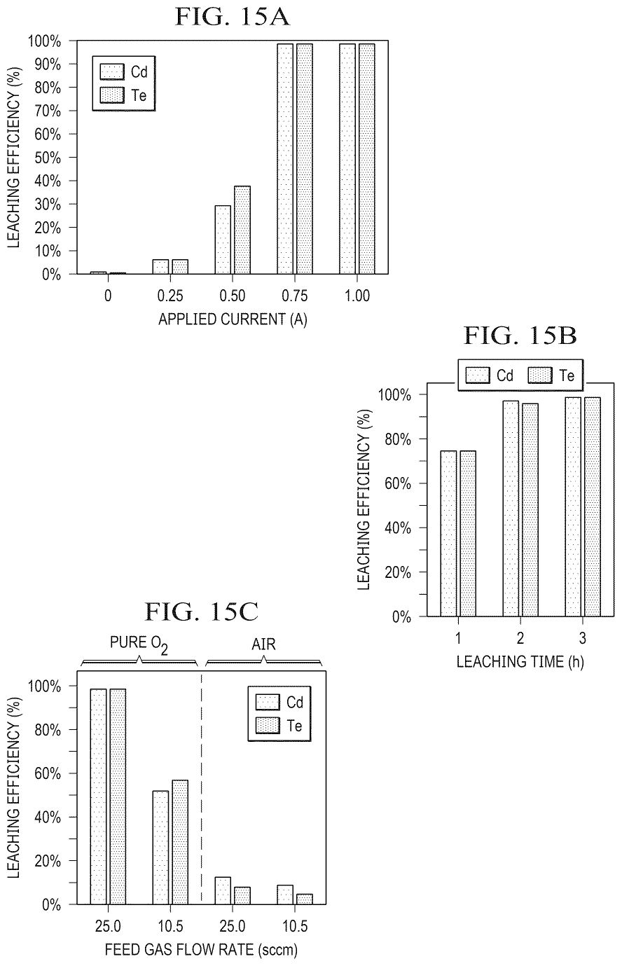

Impact of Applied Current on Leaching Efficiencies of Cd and Te in EC-Generated H₂O₂ Leaching—Leaching experiments were carried out with CdTe PV material with a pack density of 1250 g/L at 25° C. In addition, the experiments were carried out by varying the applied current up to 1 A at constant time of 3 hours and constant O₂ flow rate of 25 sccm from the gas tank and 4 sccm from the anode chamber. The results are shown in FIG. 15A, which is a graph that shows the relationship between applied current and leaching efficiency of Cd and Te. FIG. 15A highlights the importance of applied current on the leaching efficiencies of Cd and Te. With no current applied, the leaching efficiencies were less than 1% for both Cd and Te. However, leaching efficiencies of Cd and Te increased rapidly upon increasing the current. For example, at an applied current of 0.25 A the leaching efficiencies were 5-6%, at an applied current of 0.50 A the leaching efficiencies were 30-36%, at an applied current of 0.75 A the leaching efficiencies were 99%, and at an applied current of 1 A the leaching efficiencies were 99%. Thus, leaching experiments showed a rapid increase in the leaching efficiencies with increasing applied current, given that leaching efficiencies went from less than 1% to near-unity (e.g., 99%) as shown by FIG. 15A.

Impact of Leaching Time on Leaching Efficiencies of Cd and Te in EC-Generated H₂O₂ Leaching—Time dependent leaching experiments were carried out with CdTe PV material with a pack density of 1250 g/L at 25° C. This set of experiments was performed with variable leaching time up to 3 hours at constant current of 1 A and constant O₂ flow rate of 25 sccm from the gas tank and 4 sccm from the anode chamber. The results are shown in FIG. 15B, which is a graph that shows the relationship between leaching time and leaching efficiency of Cd and Te. FIG. 15B underscores the impact of time on the leaching efficiencies of Cd and Te, with increased leaching time leading to higher leaching efficiencies. For instance, leaching efficiencies increased from 75% to 99% when increasing the leaching time from 1 hour to 3 hours.

Impact of Feed Gas Composition and Flow Rate on Leaching Efficiencies of Cd and Te in EC-Generated H₂O₂ Leaching—Experiments were done investigating the impact of feed gas composition from the gas tank and the feed gas flow rate on the EC-generated H₂O₂ leaching process on CdTe PV material with a pack density of 1250 g/L at 25° C. This set of experiments was carried out with different feed gas composition, including pure O₂ and air, as well as different flow rates of the feed gas, including 25.0 sccm and 10.5 sccm at a constant applied current of 1 A, constant EC-generated O₂ flow rate of 4 sccm from the anode chamber 1308, and a leaching time of 3 hours. The results are shown in FIG. 15C, which is a graph that shows the relationship between feed gas flow rate/composition and leaching efficiency of Cd and Te. FIG. 15C highlights the importance of O₂ on the leaching efficiencies of Cd and Te. When pure O₂ was used as a feed gas from the tank at a flow rate of 25 sccm, the leaching efficiencies were found to be 99%. However, decreasing the O₂ flow rate to 10.5 sccm led to a rapid decrease in the leaching efficiencies to 52-57%. When using air as the feed gas at flow rates of 25 sccm and 10.5 sccm, the leaching efficiencies were found to be significantly decreased to 8-12% and 5-9%, respectively.

### Stability Diagrams

To better understand the chemical process of H₂O₂-assisted leaching of CdTe PV material in aqueous H₂SO₄ solution, thermodynamic computational simulations were developed.

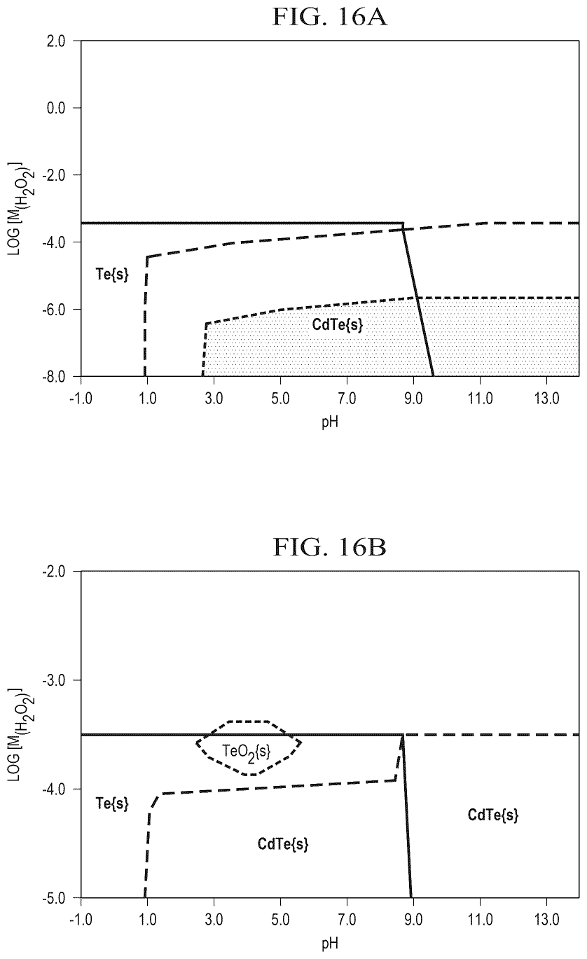

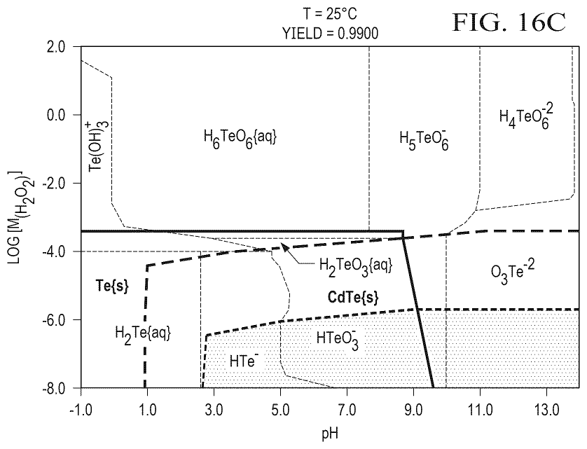

Thermodynamic computational simulations allowed for the prediction of the stabilities of different chemical species in the precipitating solid phase and aqueous solution phase pertinent to the CdTe PV material under H₂O₂-assisted leaching conditions in aqueous H₂SO₄ at 25° C., as shown in the stability diagrams in FIG. 16A to FIG. 16C. The simulated conditions accounted for variations in pH and concentrations of CdTe, H₂O₂, and H₂SO₄. FIG. 16A depicts the precipitation of elemental Te and CdTe at low H₂O₂ concentrations (1×10⁻⁸ to 1×10⁻³ M) as a function of pH. Elemental Te precipitated in the very low pH range between −1 and 1, followed by a region of mixed solid precipitation (Te and CdTe) between pH 1 and 9. Beyond pH 9, only CdTe precipitated. FIG. 16B, showing a closer look of FIG. 16A, reveals the formation of TeO₂ within a narrow range of H₂O₂ concentrations (1×10⁴ to 1×10^{-3.5} M) and Ph (1.5 to 5.5). However, H₂O₂ concentrations beyond 1×10⁻³ M resulted in complete solubilization with all the elements existing in the aqueous solution phase. FIG. 16C illustrates the composition of the aqueous solution phase with dominant dissolved Te species across various pH and H₂O₂ concentrations, along with precipitating solid phases. At higher H₂O₂ concentrations and at low pH, Te(OH)₃⁺ was the dominant species in aqueous solution, followed by the neutral species H₆TeO₆ over a broader pH range up to pH 7. Conversely, at higher alkaline pH levels, the dominant species were H₅TeO₆⁻ and H₄TeO₆²⁻. While constructing the stability diagrams, all relevant oxidation states of Te (−2, 0, +4, +6), Cd (0, +2), and oxygen (−1, 0) were considered, encompassing various forms of aqueous ionic complexes.

Te⁰ and Ce⁰ Recovery

An electrodeposition/electrowinning (ED/EW) system (similar to the one in FIG. 4) was created for recovering Te⁰ and Ce⁰ from 40 mL aqueous surrogates of pure 500 ppm Te⁴⁺ and 500 ppm Cd²⁺ solutions in 0.5 M Na₂SO₄ and 0.5 M H₂SO₄ at room temperature. This system used titanium (electroactive surface area: 17.76 cm²) as the cathode and IrO₂-coated platinum as the anode. Electrodeposition (ED) was monitored via chronoamperometry (current vs. time) by applying different cathodic potentials. After ED, the metal deposits were dissolved in 50% HNO₃ and the metal contents were analyzed with AAS and ICP-MS. Metal recovery yield (%) via ED was calculated as:

$$Metal recovery yield ( \% ) = [ \frac{Amount of metal in deposit}{Initial amount of metal in surrogate} ] \times 100 \% \qquad ( 11 )$$

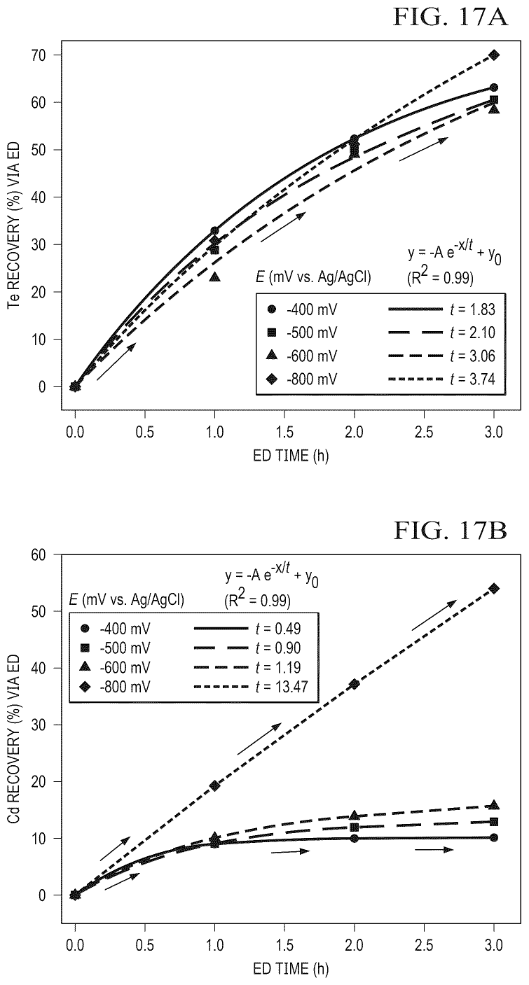

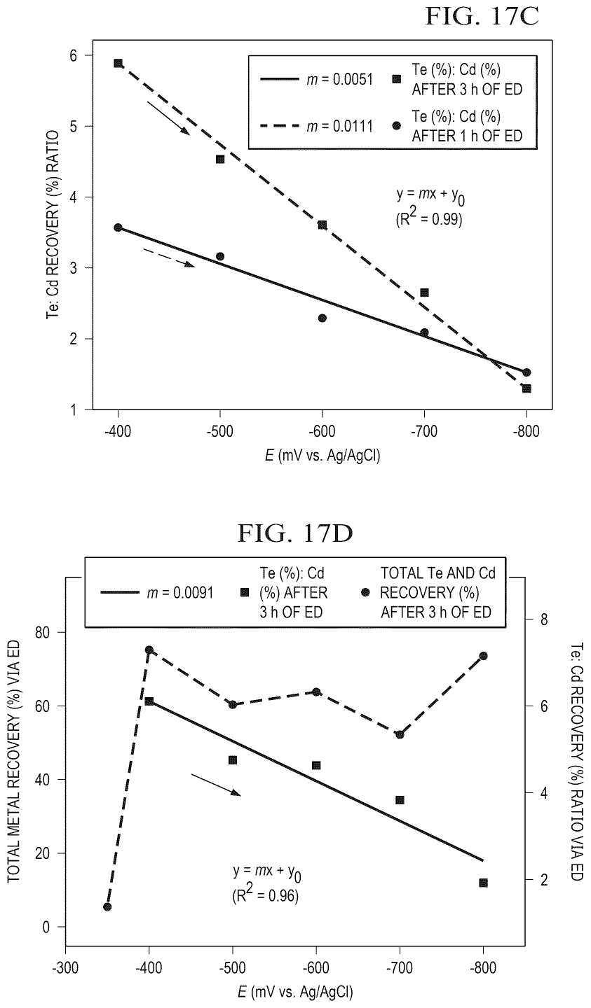

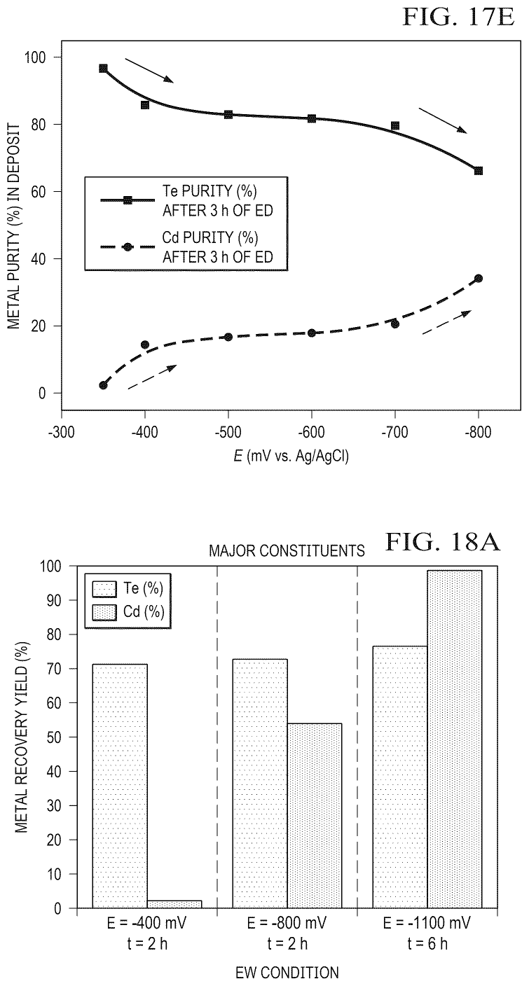

ED performance was evaluated by varying the cathodic reduction potential (E: −400 to −β800 mV vs. Ag/AgCl) as a function of time (up to 3 hours). FIG. 17A and FIG. 17B are graphs that show the relationship between ED time and metal recovery via ED at varying values for cathodic reduction potential. FIG. 17A and FIG. 17B show the ED results on Te⁰ and Ce⁰ recovery from pure Te⁴⁺ and Cd²⁺ surrogates (500 ppm), respectively, and reveal that metal recovery yields increased exponentially with time. The results also delineated the impact of cathodic reduction potential on recovery yield. While Te⁰ recovery yield in 3 hours reached 60-70% between −400 mV and −800 mV, Ce⁰ recovery yield in 3 hours increased from 10-15% at ≤−600 mV to 54% at −800 mV. The exponential curve fits underscore the impacts of the metal itself and the cathodic reduction potential on the time ‘t’ that is projected to be required to achieve 63% of the maximum possible metal recovery yield at the steady/saturation state. For instance, for Te⁰, the projections from the exponential fits suggest that it will take only 2-times longer to achieve 63% of the steady-state recovery yield at −800 mV (1˜3.7 hours) than that at −400 mV (+˜1.8 hours). However, for Cd⁰, the projections suggest that it will take 27-times as long to achieve 63% of the steady-state recovery yield at −800 mV (t˜13.5 hours) than that at −400 mV (t˜0.5 hours).

FIG. 17C is a graph that shows the relationship between cathodic reduction potential and the Te: Cd recovery ratio at varying ED times. FIG. 17C shows that the ratio of Te⁰ and Cd⁰ recovery yields decreased linearly with increasing cathodic reduction potential. Recovery yield of Te⁰ over Cd⁰ after 3 hours ED was 6-fold higher at −400 mV while the difference is insignificant at −800 mV. Further, the slope “m” of linear regression for 3 hours was 2-fold higher than that for 1 hour. This suggests that selectivity in Te⁰ recovery over Cd⁰ is better at longer time. Overall, these ED results suggest that: 1) Te⁰ recovery yield is better at a lower cathodic reduction potential (−400 mV) while Cd⁰ recovery yield is better at a higher cathodic reduction potential (−800 mV), and 2) both Te⁰ and Cd⁰ recovery yields are better at longer time (3 hours). Thus, selective recovery of Te⁰ over Cd⁰ is possible using ED. The ED for 3 hours was studied on 40 mL of aqueous surrogates in 0.5 M Na₂SO₄ and 0.5 M H₂SO₄ of binary mixtures (1:1) of Te⁴⁺ and Cd²⁺ with each metal content of 2400 ppm mimicking that in EC-generated leachate of CdTe PV material. FIG. 17D is a graph that shows the relationship between cathodic reduction potential and total metal recovery via ED. FIG. 17D shows that the total metal (Te⁰ and Cd⁰) recovery yield increased from 6% at −350 mV to 74% at −400 mV, a difference of only −50 mV, after 3 hours ED. Notably, the total metal recovery remained similar (˜74%) at a higher cathodic potential (−800 mV). However, it is also important to note that the ratio of Te⁰ recovery over Ce⁰ in the binary mixture decreased linearly with increasing cathodic reduction potential. For instance, the selectivity factor in Te⁰ recovery over Ce⁰ is 6-fold at −400 mV while the same is 2-fold at −800 mV. These 3-hour ED results for binary mixed metal surrogates at 2400 ppm are consistent with the 3-hour ED results obtained for pure metal surrogates at 500 ppm described above. Chemical purity analyses (ICP-MS and AAS) revealed the formation of Te⁰-Ce⁰ co-deposits via 3 hours ED of binary mixture surrogates. FIG. 17E is a graph that shows the relationship between cathodic reduction potential and metal purity in ED deposit. FIG. 17E shows that metal purity in the recovered co-deposit varied as a function of cathodic reduction potential. Increasing cathodic potential from −350 mV to −800 mV decreased Te⁰ purity in the co-deposit from 97% to 66% while it increased Ce⁰ purity from 3% to 34%. These results suggest that the relative recovery yields and purities of Te⁰ and Ce⁰ as isolated products from their binary aqueous mixtures can be modulated by controlling parameters such as cathodic reduction potential and time.

Selective Isolation of Te⁰ and Ce⁰ Over Other Metals from a Mixed-Metal EC Leachate

EC leachate of CdTe PV material was prepared with 30 g CdTe PV material and leaching at 1 A current, 3 hours time, and 25 sccm O₂ flow, which allows near-quantitative extraction efficiencies (18 99%) of Te and Cd in 0.5 M Na₂SO₄ and 0.5 M H₂SO₄ at room temperature. ICP-MS analysis showed that this EC leachate contained: i) Te (1858 ppm) and Cd (1890 ppm) as the major constituents, ii) Fe (312 ppm), Se (102 ppm), and Al (54 ppm) as the minor constituents, and iii) Zn (9 ppm), Cu (3 ppm), Pb (2 ppm), and Sn (<1 ppm) as the trace constituents. This mixed-metal EC leachate was directly used as the electrolyte for recovering the zero-valent metals via EW wherein Ti and IrO₂-coated Pt were used as cathode 118 and anode 116. The process was monitored via chronoamperometry by applying different cathodic potentials and time. The EW metal co-deposits were dissolved in 50% HNO₃ and the metal contents were analyzed with ICP-MS. Metal recovery yield (%) and metal purity (%) via EW were calculated as:

$$Metal recovery yield ( \% ) = [ \frac{Amount of a metal in the EW deposit}{Initial amount of that metal in the EC leachate} ] \times 100 \% \qquad ( 12 )$$

$$Metal purity ( \% ) = [ \frac{Amount of a metal in the EW deposit}{Sum amounts of all metals in the EW deposit} ] \times 100 \% \qquad ( 13 )$$

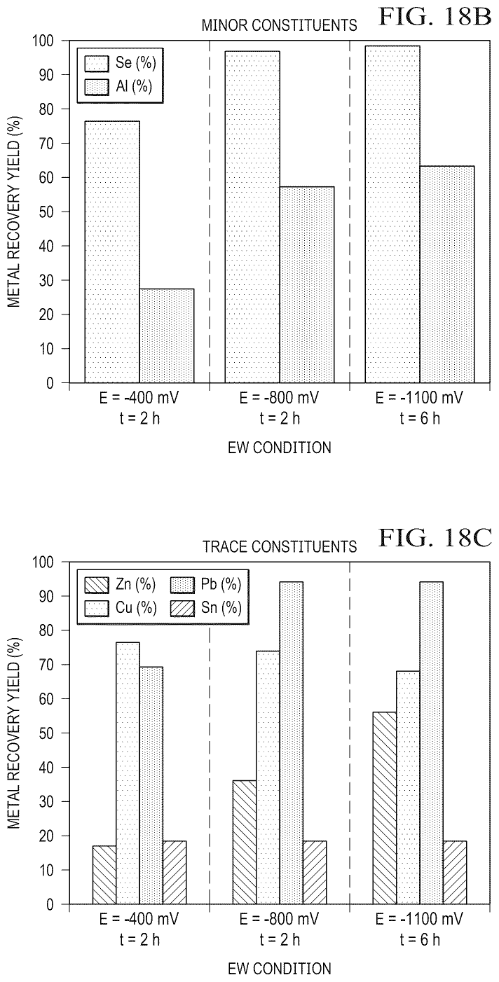

EW experiments were performed on the EC leachate of CdTe PV material with binary mixture surrogates of Te and Cd with a ratio of 1:1 at ˜2000 ppm each. We carried out EW on the EC leachate at three different conditions of cathodic reduction potential (E vs. Ag/AgCl) and time (h): i) −400 mV for 2 hours, ii) −800 mV for 2 hours, and iii) −1100 mV for 6 hours. FIG. 18A, FIG. 18B, and FIG. 18C show the changes in metal recovery yields via EW of EC leachate under these three conditions.

FIG. 18A shows changes in recovery yields of the major (1800-1900 ppm) metal constituents of the EC leachate (e.g., Te and Cd). While increasing the cathodic potential from −400 mV (2 hours) to −800 mV (2 hours) and −1100 mV (6 hours) led to a slight increase in Te⁰ recovery yield from 71% to 77%, it resulted in a remarkable increase in Ce⁰ recovery yield from <2% to >99%. FIG. 18B shows the changes in the recovery yields of the minor (50-300 ppm) metal constituents of the EC leachate (e.g., Fe, Se, and Al). Under these EW conditions, Fe remained in the leachate and was not recovered in the deposit. However, both Se⁰ and Al⁰ were recovered via EW. Se⁰ recovery yield increased from 77% to 99% when increasing the cathodic potential from −400 mV to −1100 mV. Al⁰ recovery yield increased from 28% to 64% with the same increase in cathodic potential. FIG. 18C shows changes in the recovery yields of the trace (1-10 ppm) metal constituents of the EC leachate (e.g., Zn, Cu, Pb, and Sn). Increasing the cathodic potential from −400 mV to −1100 mV increased Zn⁰ and Pb⁰ recovery yields from 17% to 57% and from 69% to 94%, respectively. However, the cathodic potential increase led to a decrease in Cu⁰ recovery yield from 77% to 68%, and the Sn⁰ recovery yield was unaltered (19%). These results demonstrate that EW is a viable pathway to isolate Te⁰ and Cd⁰ from the EC leachate of CdTe PV material with high recovery yields (77% to 99%) while also co-recovering other metals comprising the minor (Se⁰ and Al⁰) and trace (Zn⁰, Cu⁰, Pb⁰, etc.) constituents of the EC leachate in moderate yields (55-94%).

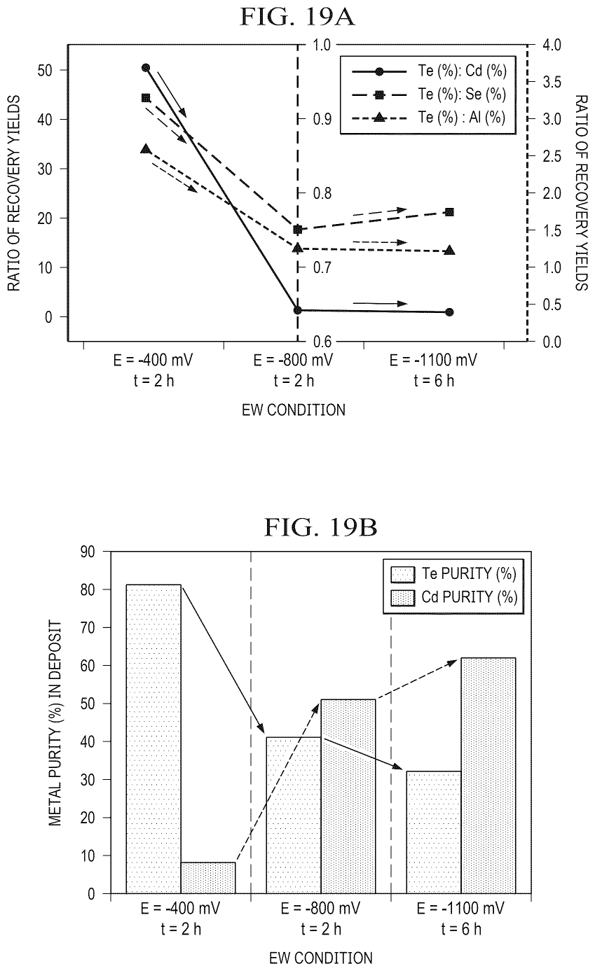

The EW results on EC leachate showed that a higher cathodic potential was beneficial in increasing metal recovery yields. However, a higher cathodic potential was detrimental to selective recovery of Te from the EC leachate by EW. FIG. 19A shows the ratio of recovery yields for Te: Cd, Te: Se, and Te: Al at varying EW conditions. FIG. 19A further shows that the ratio of Te⁰ and Ce⁰ recovery yields was 51-fold at −400 mV while the same dropped to 0.77-fold at −1100 mV. The same trend was observed, albeit in lower magnitude, for the ratios of Te⁰ recovery yield over Se⁰ (0.93-fold to 0.77-fold) and Al⁰ (2.6-fold to 1.2-fold). These EW results suggest that a lower cathodic potential is beneficial for recovering Te⁰ with higher selectivity factor over other metals. This is further bolstered by the chemical purity analysis of the multi-metal co-deposits (containing a mixture of Te⁰, Cd⁰, Se⁰, Al⁰, Zn⁰, Cu⁰, Pb⁰, Sn⁰) obtained via EW. FIG. 19B shows the metal purity in deposit at varying EW conditions. FIG. 19B further shows that Te⁰ purity in the co-deposit was the highest (81%) at −400 mV and decreases progressively with increasing cathodic potentials to −800 mV (41%) and to −1100mV (32%). In contrast, Ce⁰ purity in the co-deposit is the lowest (9%) at −400 mV and increases gradually with increasing cathodic potentials to −800 mV (51%) and to −1100 mV (62%). These results underscore how cathodic reduction potential and time governs the outcome of Te⁰ and Ce⁰ recovery from a CdTe EC leachate via EW and that there exists trade-offs between recovery yield, selectivity factor, and purity of these metals. EW allows isolating Te with a recovery yield of 71%, a purity of 81%, and a selectivity factor of 51 over Cd, whereas, for isolating Cd, EW allows a recovery yield of 99% and a purity of 62%. In essence, these experiments demonstrated the viability of EW for recovery, downstream separation, and isolation of Te⁰, Cd⁰, and other metals of interest from EC-generated leachate of CdTe PV material.

What is claimed is:

1. An electrochemical leaching system for recovering metals from electronic waste, the electrochemical leaching system comprising:
an electrochemical cell, the electrochemical cell configured to produce a hydrogen peroxide-enriched electrolyte;
a power supply in electrical communication with the electrochemical cell; and
a leaching reactor configured to contain fragmented electronic waste and to produce a metal-enriched electrolyte from the fragmented electronic waste,
the electrochemical cell and the leaching reactor in fluid communication with each other.

2. The electrochemical leaching system of claim 1, further comprising a recovery electrochemical cell in fluid communication with the electrochemical cell and the leaching reactor, the recovery electrochemical cell configured to recover one or more metals of interest from the metal-enriched electrolyte.

3. The electrochemical leaching system of claim 1, further comprising a recirculation vessel in fluid communication with the electrochemical cell and the leaching reactor, the recirculation vessel configured to contain the hydrogen peroxide-enriched electrolyte.

4. The electrochemical leaching system of claim 1, wherein the electrochemical cell comprises a cathode chamber, an electrolyte chamber, and an anode chamber.

5. The electrochemical leaching system of claim 4, wherein a gas diffusion electrode is between the cathode chamber and the electrolyte chamber.

6. The electrochemical leaching system of claim 4, wherein a bipolar membrane or a cation exchange membrane is between the electrolyte chamber and the anode chamber.

7. The electrochemical leaching system of claim 4, wherein an anode in the anode chamber is formulated to oxidize water to produce oxygen.

8. The electrochemical leaching system of claim 4, wherein a gas diffusion electrode between the cathode chamber and the electrolyte chamber is formulated to reduce oxygen to hydrogen peroxide.

9. A method of recovering one or more metals from electronic waste, the method comprising:
introducing fragmented electronic waste into a leaching reactor;
introducing an electrolyte into an electrochemical cell in fluid communication with the leaching reactor;
introducing an oxygen containing gas into the electrochemical cell;
applying an electrical potential to the electrochemical cell to produce hydrogen peroxide from the oxygen containing gas in the electrochemical cell;
combining the hydrogen peroxide with the electrolyte to form a hydrogen peroxide-enriched electrolyte;
contacting the fragmented electronic waste in the leaching reactor with the hydrogen peroxide-enriched electrolyte to dissolve at least one metal from the fragmented electronic waste into the electrolyte and to form a metal-enriched electrolyte; and
recovering one or more metals from the metal-enriched electrolyte.

10. The method of claim 9, wherein introducing fragmented electronic waste into a leaching reactor comprises introducing fragmented electronic waste comprising one or more of solar panels, cell phones, printed circuit boards, laptop computers, desktop computers, and televisions into the leaching reactor.

11. The method of claim 9, wherein introducing fragmented electronic waste into a leaching reactor comprises introducing fragmented electronic waste comprising one or more of tellurium (Te), cadmium (Cd), iron (Fe), nickel (Ni), cobalt (Co), selenium (Se), aluminum (Al), zinc (Zn), copper (Cu), lead (Pb), and tin (Sb) into the leaching reactor.

12. The method of claim 9, wherein introducing an oxygen containing gas into the electrochemical cell comprises introducing oxygen gas or air into the electrochemical cell.

13. The method of claim 9, wherein recovering one or more metals from the metal-enriched electrolyte comprises recovering the one or more metals after contacting the fragmented electronic waste with the hydrogen peroxide-enriched electrolyte.

14. A method of recovering one or more metals from electronic waste, the method comprising:
introducing fragmented electronic waste from solar panels into a leaching reactor;
introducing an electrolyte into an electrochemical cell in fluid communication with the leaching reactor;
introducing an oxygen containing gas into the electrochemical cell;
applying an electrical current between an anode and a cathode of the electrochemical cell to produce hydrogen peroxide in the electrochemical cell;
combining the hydrogen peroxide with the electrolyte to form a hydrogen peroxide-enriched electrolyte;
leaching at least one metal from the fragmented electronic waste into the hydrogen peroxide-enriched electrolyte to form a metal-enriched electrolyte;
recovering the at least one metal from the metal-enriched electrolyte to form a metal-depleted electrolyte; and
combining the metal-depleted electrolyte with hydrogen peroxide in the electrochemical cell.

15. The method of claim 14, wherein introducing an electrolyte into an electrochemical cell comprises introducing an aqueous acidic sulfate electrolyte into an electrolyte chamber.

16. The method of claim 14, wherein introducing an oxygen containing gas into the electrochemical cell comprises introducing the oxygen containing gas into a cathode chamber of the electrochemical cell.

17. The method of claim 16, further comprising introducing an aqueous base into an anode chamber of the electrochemical cell.

18. The method of claim 17, wherein applying an electrical current between an anode and a cathode of the electrochemical cell comprises oxidizing water from the aqueous base to produce oxygen.

19. The method of claim 14, wherein recovering the at least one metal from the metal-enriched electrolyte comprises recovering one or more of cadmium and tellurium.

20. The method of claim 14, wherein recovering the at least one metal from the metal-enriched electrolyte comprises recovering solubilized metal ions from the metal-enriched by electrowinning.
